(19) United States
(12) Patent Application Publication
(10) Pub. No.: US 2026/0323435 A1
(43) Pub. Date: Oct. 15, 2026

(54) NODE AND USER EQUIPMENT IN WIRELESS COMMUNICATION SYSTEM AND METHOD PERFORMED BY THE SAME

(71) Applicant: SAMSUNG ELECTRONICS CO., LTD., Suwon-si, Gyeonggi-do (KR)

(72) Inventors: Yu PAN, Beijing (CN); Weiwei WANG, Beijing (CN); Hong WANG, Beijing (CN); Lixiang XU, Beijing (CN)

(21) Appl. No.: 19/123,690

(22) PCT Filed: Feb. 14, 2024
(86) PCT No.: PCT/KR2024/095128

§ 371 Date: Apr. 23, 2025

(30) Foreign Application Priority Data
Feb. 15, 2023 (CN) 202310140076.3
Apr. 4, 2023 (CN) 202310357983.3
Sep. 25, 2023 (CN) 202311246196.8

(51) Int. Cl. H04W 36/04; H04W 36/00

(52) U.S. Cl. CPC H04W 36/04; H04W 36/0058; H04W 36/0094

(57) ABSTRACT

The disclosure relates to a 5G or 6G communication system for supporting a higher data transmission rate. The invention provides a node and user equipment in a wireless communication system and a method performed by the same. A method performed by a user equipment (UE) in a wireless communication system provided by the present disclosure includes: receiving a first message from a first node, wherein the first message includes information of at least one first L1/L2-triggered mobility (LTM) candidate cell; transmitting a measurement report to the first node; and receiving a second message from the first node, wherein the second message includes information of at least one second LTM candidate cell or information for indicating at least one first LTM candidate cell for which measurement needs to be performed.

### TECHNICAL FIELD

The present disclosure relates to a technical field of wireless communication, and more specifically, to a node and user equipment in a wireless communication system and a method performed by the same.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The purpose of this application is to be able to solve at least one of the drawbacks of the prior art.

The introduction of LTM may lead to the increase of the UE measurement and the possibility of LTM handover failure.

### Solution to Problem

Embodiments of the present disclosure provide a method performed by a user equipment (UE) in a wireless communication system, which includes: receiving a first message from a first node, wherein the first message includes information of at least one first L1/L2-triggered mobility (LTM) candidate cell and/or at least one secondary cell information; transmitting a measurement report to the first node; and receiving a second message from the first node, wherein the second message includes information of at least one second LTM candidate cell and/or at least one secondary cell information or information for indicating at least one first LTM candidate cell for which measurement needs to be performed.

According to embodiments of the present disclosure, the first message further includes L1 measurement configuration information, wherein the L1 measurement configuration information includes a neighboring cell L1 measurement trigger condition; wherein the UE triggers a neighboring cell L1 measurement based on the neighboring cell L1 measurement trigger condition; and wherein the neighboring cell L1 measurement trigger condition includes that a reference signal receiving power (RSRP) value of a special cell is lower than a first neighboring cell measurement threshold.

According to embodiments of the present disclosure, the UE receives the L1 measurement configuration information by the following: the L1 measurement configuration information is received by the UE from a second node; or the L1 measurement configuration information is received by the UE from a second node, wherein the L1 measurement configuration information is received by the second node from the first node after the second node indicates the first node to transmit the L1 measurement configuration information.

According to embodiments of the present disclosure, the first message further includes L3 measurement configuration information, wherein the L3 measurement configuration information includes a neighboring cell L3 measurement trigger condition; wherein the UE triggers a neighboring cell L3 measurement based on the neighboring cell L3 measurement trigger condition; and wherein the neighboring cell L3 measurement trigger condition includes at least one of the following: both reference signal receiving power (RSRP) values of a special cell and an LTM candidate cell are lower than a first neighboring cell measurement threshold, and a RSRP value of a special cell is lower than a second neighboring cell measurement threshold.

According to embodiments of the present disclosure, the first message further includes L3 measurement configuration information, wherein the L3 measurement configuration information includes a condition for event-triggered measurement reporting, wherein the method further includes: when a L3 measurement result meets the condition for event-triggered measurement reporting, the UE transmits a second measurement report to the first node; wherein the condition for event-triggered measurement reporting includes at least one of the following: a measurement result of a serving cell is lower than a threshold; a measurement result of a neighboring cell is higher than a measurement result of a special cell or an LTM candidate cell and exceeds an offset; a measurement result of a special cell or an LTM candidate cell is lower than a first threshold, while a measurement result of a neighboring cell is higher than a second threshold; a measurement result of an LTM candidate cell is lower than a threshold; a measurement result of a neighboring cell is higher than a measurement result of an LTM candidate cell and exceeds an offset; a measurement result of an LTM candidate cell is lower than a first threshold, while a measurement result of a neighboring cell is higher than a second threshold; a measurement result of a neighboring cell is higher than a measurement result of an LTM candidate cell and exceeds an offset.

According to embodiments of the present disclosure, the condition for event-triggered measurement reporting includes an entering condition and a leaving condition of an event, wherein the entering condition and leaving condition include at least one of the following: entering condition: Ms+Hys<Thresh; leaving condition: Ms−Hys>Thresh; or, entering condition: Mn+Ofn+Ocn−Hys>Mp+Ofp+Ocp+Off, leaving condition: Mn+Ofn+Ocn+Hys<Mp+Ofp+Ocp+Off; or, entering condition: Mp+Hys<Thresh1; Mn+Ofn+Ocn−Hys>Thresh2; leaving condition: Mp−Hys>Thresh1; Mn+Ofn+Ocn+Hys<Thresh2; or, entering condition: Ml+Hys<Thresh; leaving condition: Ml−Hys>Thresh; or, entering condition: Mn+Ofn+Ocn−Hys>Ml+Ofl+Ocl+Off; leaving condition: Mn+Ofn+Ocn+Hys<Ml+Ofl+Ocl+Off; or, entering condition: Ml+Hys<Thresh1; Mn+Ofn+Ocn−Hys>Thresh2; leaving condition: Ml−Hys>Thresh1; Mn+Ofn+Ocn+Hys<Thresh2; or, entering condition: Mn+Ocn−Hys>Ml+Ocl+Off; leaving condition: Mn+Ocn+Hys<Ml+Ocl+Off; wherein, Ms is a measurement result of a serving cell; Hys is a hysteresis parameter of an event; Thresh is a threshold of an event; Mn is a measurement result of a neighboring cell; Ofn is a measurement object specific offset of a reference signal of a neighboring cell; Ocn is a cell specific offset of a neighboring cell; Mp is a measurement result of a special cell or LTM candidate cell; Ofp is a measurement object specific offset of a special cell or LTM candidate cell; Ocp is a cell specific offset of a special cell or LTM candidate cell; Off is an offset parameter of an event; Thresh1 is a threshold parameter 1 of an event; Thresh2 is a threshold parameter 2 of an event; Ml is a measurement result of an LTM candidate cell; Of is a measurement object specific offset of an LTM candidate cell; Ocl is a cell specific offset of an LTM candidate cell.

According to embodiments of the present disclosure, wherein the measurement report is a first measurement report or a second measurement report, wherein the first measurement report includes an L1 measurement result and the second measurement report includes an L3 measurement result.

According to embodiments of the present disclosure, the method further includes: receiving a third message from the first node, wherein the third message includes an identification of a target cell; wherein if the UE does not successfully access the target cell, the UE performs a random access process, and if the random access process fails, the UE performs cell selection.

According to embodiments of the present disclosure, the method further includes: when LTM handover fails or L3 handover fails, performing cell selection; and if a selected target cell is an LTM candidate cell, transmitting an LTM handover completion indication to the target cell or performing a random access process.

According to embodiments of the present disclosure, performing a random access process includes transmitting a Message 3 (MSG3) or a Message A (MSGA) to the target cell; wherein the MSG3 or MSGA transmitted to the target cell includes a cell radio network temporary identification (C-RNTI) allocated to the UE by the target cell.

Embodiments of the present disclosure provide a method performed by a first node in a wireless communication system, which includes: transmitting a first message to a user equipment (UE), wherein the first message includes information of at least one first L1/L2-triggered mobility (LTM) candidate cell and/or at least one secondary cell information; receiving a measurement report from the UE; and transmitting a second message to the UE, wherein the second message includes information of at least one second LTM candidate cell and/or at least one secondary cell information or information for indicating at least one first LTM candidate cell for which measurement needs to be performed.

According to embodiments of the present disclosure, the first message further includes L1 measurement configuration information, wherein the L1 measurement configuration information includes a neighboring cell L1 measurement trigger condition; wherein the UE triggers a neighboring cell L1 measurement based on the neighboring cell L1 measurement trigger condition; and wherein the neighboring cell L1 measurement trigger condition includes that a reference signal receiving power (RSRP) value of a special cell is lower than a first neighboring cell measurement threshold.

According to embodiments of the present disclosure, the UE receives the L1 measurement configuration information by the following: the L1 measurement configuration information is received by the UE from a second node; or the L1 measurement configuration information is received by the UE from a second node, wherein the L1 measurement configuration information is received by the second node from the first node after the second node indicates the first node to transmit the L1 measurement configuration information.

According to embodiments of the present disclosure, the first message further includes L3 measurement configuration information, wherein the L3 measurement configuration information includes a neighboring cell L3 measurement trigger condition; wherein the UE triggers a neighboring cell L3 measurement based on the neighboring cell L3 measurement trigger condition; and wherein the neighboring cell L3 measurement trigger condition includes at least one of the following: both reference signal receiving power (RSRP) values of a special cell and an LTM candidate cell are lower than a first neighboring cell measurement threshold, and a RSRP value of a special cell is lower than a second neighboring cell measurement threshold.

According to embodiments of the present disclosure, the first message further includes L3 measurement configuration information, wherein the L3 measurement configuration information includes a condition for event-triggered measurement reporting, wherein the method further includes: when a L3 measurement result meets the condition for event-triggered measurement reporting, receiving a second measurement report from the UE and transmitting the second measurement report to a second node; wherein the condition for event-triggered measurement reporting includes at least one of the following: a measurement result of a serving cell is lower than a threshold; a measurement result of a neighboring cell is higher than a measurement result of a special cell or an LTM candidate cell and exceeds an offset; a measurement result of a special cell or an LTM candidate cell is lower than a first threshold, while a measurement result of a neighboring cell is higher than a second threshold; a measurement result of an LTM candidate cell is lower than a threshold; a measurement result of a neighboring cell is higher than a measurement result of an LTM candidate cell and exceeds an offset; a measurement result of an LTM candidate cell is lower than a first threshold, while a measurement result of a neighboring cell is higher than a second threshold; a measurement result of a neighboring cell is higher than a measurement result of an LTM candidate cell and exceeds an offset.

According to embodiments of the present disclosure, the condition for event-triggered measurement reporting includes an entering condition and a leaving condition of an event, wherein the entering condition and leaving condition include at least one of the following: entering condition: Ms+Hys<Thresh; leaving condition: Ms−Hys>Thresh; or, entering condition: Mn+Ofn+Ocn−Hys>Mp+Ofp+Ocp+Off; leaving condition: Mn+Ofn+Ocn+Hys<Mp+Ofp+Ocp+Off, or, entering condition: Mp+Hys<Thresh1; Mn+Ofn+Ocn−Hys>Thresh2; leaving condition: Mp−Hys>Thresh1; Mn+Ofn+Ocn+Hys<Thresh2; or, entering condition: Ml+Hys<Thresh; leaving condition: Ml−Hys>Thresh; or, entering condition: Mn+Ofn+Ocn−Hys>Ml+Ofl+Ocl+Off; leaving condition: Mn+Ofn+Ocn+Hys<Ml+Ofl+Ocl+Off; or, entering condition: Ml+Hys<Thresh1; Mn+Ofn+Ocn−Hys>Thresh2; leaving condition: Ml−Hys>Thresh1; Mn+Ofn+Ocn+Hys<Thresh2; or, entering condition: Mn+Ocn−Hys>Ml+Ocl+Off; leaving condition: Mn+Ocn+Hys<Ml+Ocl+Off; wherein, Ms is a measurement result of a serving cell; Hys is a hysteresis parameter of an event; Thresh is a threshold of an event; Mn is a measurement result of a neighboring cell; Ofn is a measurement object specific offset of a reference signal of a neighboring cell; Ocn is a cell specific offset of a neighboring cell; Mp is a measurement result of a special cell or LTM candidate cell; Ofp is a measurement object specific offset of a special cell or LTM candidate cell; Ocp is a cell specific offset of a special cell or LTM candidate cell; Off is an offset parameter of an event; Thresh1 is a threshold parameter 1 of an event; Thresh2 is a threshold parameter 2 of an event; Ml is a measurement result of an LTM candidate cell; Ofl is a measurement object specific offset of an LTM candidate cell; Ocl is a cell specific offset of an LTM candidate cell.

According to embodiments of the present disclosure, the method further includes: if the received measurement report is a second measurement report, transmitting the second measurement report to a second node; and if the received measurement report is a first measurement report, performing one of the following operations: performing LTM handover; transmitting information for indicating at least one first LTM candidate cell for which measurement needs to be performed to the UE; or transmitting a third measurement report to a second node, wherein the third measurement report includes at least one of the following: an L1 measurement result and an identification of a cell with a quality lower than a measurement threshold.

According to embodiments of the present disclosure, the method further includes: receiving load status information of an LTM candidate cell; and transmitting information for indicating at least one first LTM candidate cell for which measurement needs to be performed to the UE.

According to embodiments of the present disclosure, the second message is transmitted to the UE through a Media Access Control Control Element (MAC CE) or downlink control information (DCI).

According to embodiments of the present disclosure, the method further includes: receiving L1 measurement configuration indication information from a second node and transmitting L1 measurement configuration information to the second node, wherein the L1 measurement configuration indication information is used to indicate that the L1 measurement configuration information is provided by the first node.

According to embodiments of the present disclosure, the method further includes: transmitting a third message to the UE, wherein the third message includes an identification of a target cell; wherein if the UE does not successfully access the target cell, the UE performs a random access process, and if the random access process fails, the UE performs cell selection.

Embodiments of the present disclosure provide a method performed by a second node in a wireless communication system, which includes: transmitting a first message to a first node, wherein the first message includes information of at least one first L1/L2-triggered mobility (LTM) candidate cell and/or at least one secondary cell information; receiving a second measurement report and/or a third measurement report from the first node, wherein the second measurement report includes an L3 measurement result; and the third measurement report includes at least one of the following: an L1 measurement result and an identification of a cell with a quality lower than a measurement threshold; and transmitting a second message to the first node based on the second measurement report or the third measurement report, wherein the second message includes information of at least one second LTM candidate cell and/or at least one secondary cell information, wherein the second message is transmitted to a user equipment (UE) through the first node.

Embodiments of the present disclosure provide a user equipment in a wireless communication system, including: a transceiver configured to transmit and receive signals; and a controller coupled to the transceiver and configured to perform methods performed by a user equipment in a wireless communication system according to embodiments of the present disclosure.

Embodiments of the present disclosure provide a node in a wireless communication system, including: a transceiver configured to transmit and receive signals; and a controller coupled to the transceiver and configured to perform methods performed by a node (e.g., a first node and/or a second node) in a wireless communication system according to embodiments of the present disclosure.

Embodiments of the present disclosure provide a computer-readable medium having computer-readable instructions stored thereon, which, when executed by a processor, can be used to implement any method according to embodiments of the present disclosure.

The methods performed by the first node and/or the second node and/or the user equipment in a wireless communication system provided by the embodiments of the present disclosure can reduce the measurement and service interruption time of the UE, thereby reducing the processing capacity and power consumption of the UE, ensuring service continuity and improving the handover performance of the UE.

### ADVANTAGEOUS EFFECTS OF INVENTION

Embodiments of the present disclosure provides a measurement manangement method and a method to improve handover performance, so as to reduce the power consumption of the UE and the requirements on the processing capacity of the UE, reduce the service interruption delay and ensure the service continuity.

### BRIEF DESCRIPTION OF DRAWINGS

The above and other aspects, features and advantages of certain embodiments of the present disclosure will be more apparent from the following description taken in con-junction with the accompanying drawings, in which:

FIG. 1 is an exemplary system architecture 100 of system architecture evolution (SAE);

FIG. 2 is an exemplary system architecture 200 according to various embodiments of the present disclosure;

FIGS. 3a and 3b respectively show a schematic diagram of a structure of MAC CE for transmitting LTM candidate cell states;

FIG. 4 shows a schematic diagram of an example method according to embodiment 1 of the present disclosure;

FIG. 5 shows a schematic diagram of an example method according to embodiment 2 of the present disclosure;

FIG. 6 shows a schematic diagram of an example method according to embodiment 3 of the present disclosure;

FIG. 7 shows a schematic diagram of an example method according to embodiment 4 of the present disclosure;

FIG. 8 shows a schematic diagram of an example method according to embodiment 5 of the present disclosure;

FIG. 9 shows a schematic diagram of an example method according to embodiment 6 of the present disclosure;

FIG. 10 shows a flowchart of a method 1000 performed by a user equipment (UE) in a wireless communication system according to embodiments of the present disclosure;

FIG. 11 shows a flowchart of a method 1100 performed by a first node in a wireless communication system according to embodiments of the present disclosure;

FIG. 12 shows a flowchart of a method 1200 performed by a second node in a wireless communication system according to embodiments of the present disclosure;

FIG. 13 shows a schematic diagram of a node 1300 in a wireless communication system according to embodiments of the present disclosure; and

FIG. 14 shows a schematic diagram of a user equipment 1400 in a wireless communication system according to embodiments of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

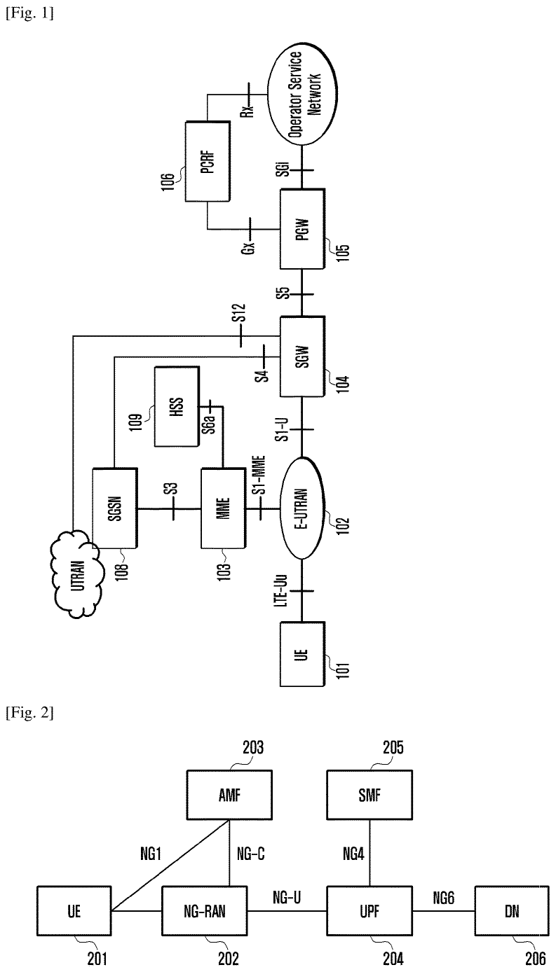

FIGS. 1 to 14 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommu-nications system (UMTS). A home subscriber server (HSS) 109 is a home subsystem of the UE, and is responsible for protecting user information including a current location of the user equipment, an address of a serving node, user security information, and packet data context of the user equipment, etc.

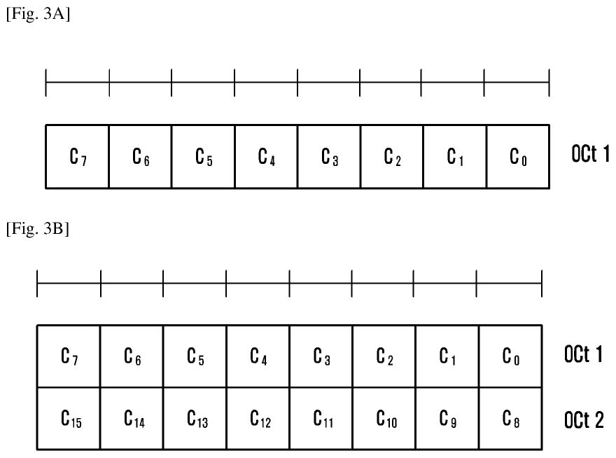

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

A detailed description of steps irrelevant to the present disclosure is omitted in the present disclosure. In the following embodiments, a 5G system is taken as an example, a CU is taken as an example of a central unit of the access network, and a DU is taken as an example of a distributed unit for description. The methods are also applicable to corresponding entities in other systems.

In the present application, a gNB may be a single base station, or a master base station/master node (MN) or a secondary base station/secondary node (SN) in Dual Connectivity (DC). A group of cells serving UE in an MN is called Master Cell Group (MCG), and a group of cells serving UE in an SN is called Secondary Cell Group (SCG). A primary cell of the MCG is called PCell (Primary Cell), and a primary cell of the SCG is called PSCell (Primary SCG Cell). When MCG or SCG adopts Carrier Aggregation (CA), other cells other than the PCell and PSCell are called Secondary Cells (SCells). An SCell corresponding to the current serving PCell and PSCell is called serving SCell. An SCell corresponding to a candidate PCell and PSCell is called candidate SCell.

In a split structure of Central Unit (CU)/Distributed Unit (DU), a source cell and a target cell may be located under the same gNB-DU or different gNB-DUs during handover.

The system supports an L1/L2-triggered mobility (LTM) handover mode, which may also be called Layer 1/Layer 2 handover (L1/L2 handover, or L1/L2 Mobility), in which a base station or gNB-DU transmits an LTM handover command or LTM handover indication to the UE through a control channel of a physical layer (L1, Layer 1) (such as PDCCH, Physical Downlink Control Channel) or a MAC CE (MAC Control Element) of a MAC layer (L2, Layer 2) or the like. The UE updates the serving cell according to a target cell in the received LTM command, that is, performs cell switch. Herein, in order to support the LTM handover, before performing the LTM handover, the base station or gNB-CU provides a set of LTM candidate cells or an LTM candidate cell list to the UE through a radio resource control (RRC) message, and indicates the UE to perform Layer 1 measurement (L1 measurement) and L1 measurement result reporting (or called L1 measurement reporting) for the candidate LTM cells. The base station or gNB-DU determines whether to perform LTM handover according to the L1 measurement result provided by the UE, and selects a suitable target cell for the UE to perform LTM handover from the LTM candidate cells. L1 measurement methods are not belong to the research scope of the present invention.

The introduction of LTM may lead to the increase of the UE measurement and the possibility of LTM handover failure. After the introduction of LTM mode, the system supports two handover modes, that is, LTM handover mode and L3 handover mode. The trigger of LTM handover mode is based on an L1 measurement result of the UE and is triggered by L1 or L2. The trigger of L3 Handover mode is based on an L3 measurement result of the UE and is triggered by the gNB-CU or an RRC layer (Layer 3 (L3)), which is called L3 handover (L3 HO) for convenience of description. The L3 handover may be a normal handover, that is, the network transmits a handover command (such as RRC reconfiguration message) and indicates UE a target cell for handover; it may also be a Conditional Handover, that is, the network transmits candidate target cells and execution conditions to the UE, and the UE evaluates the execution conditions of the candidate target cells, and, if an execution condition is fulfilled, the UE decides or selects a target cell for handover autonomously.

The LTM handover mode may be used in a Dual Connectivity (DC) system, in which the SN may change PSCell independently through an LTM mode. Therefore, the contents in the present disclosure are applicable to a scenario where MN changes PCell by LTM, and also applicable to a scenario where SN changes PCell by LTM. Therefore, the LTM candidate cell mentioned in the present disclosure may be an LTM candidate cell of PCell and an LTM candidate cell of PSCell.

For convenience of description, the concept of an LTM cell is defined in the present disclosure. For an MN in single connectivity or dual connectivity, LTM cells include the current PCell and all LTM candidate cells for the PCell change. For an SN in dual connectivity, LTM cells include the PSCell and all LTM candidate cells for the PSCell change. In other words, LTM cells may include special cells (that is, PCell and/or PSCell) and all LTM candidate cells for the special cells change. In the present application, message names are just examples, and messages may be named by other names. The sequence number of a message does not represent an order of the message being performed, but only represent the name of the message.

In order to support the cell handover of the UE, the present disclosure includes a measurement management method and a method to improve handover performance, so as to reduce the power consumption of the UE and the requirements on the processing capacity of the UE, reduce the service interruption delay and ensure the service continuity.

### (1) Measurement Management Method

A purpose of measurement management is to reduce unnecessary measurements, thus reducing the power consumption of the UE, including a trigger mechanism for a neighboring cell L1 measurement, a coordination between a neighboring cell L1 measurement and a neighboring cell L3 measurement, and the change of measurement cells in L1 measurement.

### 1. Trigger Mechanism of a Neighboring Cell L1 Measurement

A purpose of L1 measurement is to select a suitable serving cell for UE according to an L1 measurement result, so as to meet the service transmission quality requirements, and thus realize the network's support for UE mobility. If the quality of the current serving cell is good enough to meet the service transmission requirements, or the UE is not moving, it is unnecessary for the UE to perform a neighboring cell L1 measurement and report a measurement result. If an inter-frequency L1 measurement is required for the neighboring cell L1 measurement, a certain measurement gap may be required, which may cause the service transmission of the UE to be interrupted.

Therefore, the present disclosure proposes a trigger mechanism for a neighboring cell L1 measurement to prevent UE from performing unnecessary neighboring cell L1 measurements. According to the channel quality of the current SpCell (Special Cell), the UE determines whether it is necessary to trigger a neighboring cell L1 measurement. The SpCell refers to a PCell or a PSCell.
If the RSRP of the SpCell<a neighboring cell L1 measurement threshold, the UE starts to perform a neighboring cell L1 measurement.
Otherwise, the UE does not need to perform a neighboring cell L1 measurement.

Herein, the threshold for triggering the neighboring cell L1 measurement is set by the network and provided to the UE. The RSRP (Reference Signal Receiving Power) may be an SSB (Synchronization Signal/PBCH Block) RSRP, or a CSI (Channel State Information) RSRP, or RSRPs of other signals.

The neighboring cell L1 measurement threshold may be set by a gNB-DU or MAC layer, or a gNB-CU or RRC layer:
If it is set by a gNB-DU or MAC layer, it may be transmitted to the UE through a MAC Control Element (MAC CE); or it may be that the gNB-DU transmits the neighboring cell L1 measurement threshold to a gNB-CU, or the MAC layer transmits the neighboring cell L1 measurement threshold to the RRC layer, and the gNB-CU or RRC layer transmits it to the UE through an RRC message.
If it is set by a gNB-CU or RRC layer: it may be transmitted to the UE through an RRC message; or it may be that the gNB-CU transmits the neighboring cell L1 measurement threshold to a gNB-DU, or the RRC layer transmits the neighboring cell L1 measurement threshold to the MAC layer, and the gNB-DU or MAC layer transmits it to the UE through a MAC CE.

### 2. Coordination Between a Neighboring Cell L1 Measurement and Neighboring Cell L3 Measurement

If the LTM only supports Intra gNB-CU cell switch, when the UE needs to move to a cell of another gNB-CU, LTM only by means of L1 measurement will not be able to support the mobility and service continuity of the UE. Therefore, the UE needs to support both L1 measurement and L3 measurement, so as to ensure that the network can obtain enough measurement results and select a suitable cell for the UE to handover. For a neighboring cell L1 measurement, the UE will measure the quality of all LTM cells. For a neighboring cell L3 measurement, the UE will measure the quality of measurement cells included in an L3 measurement configuration, which may include Inter-RAT cells. As the UE needs to support both L1 measurement and L3 measurement, it increases the measurement processing requirements and power consumption of the UE. Therefore, the present disclosure proposes two methods of cooperation between L1 measurement and L3 measurement, which can ensure the network to obtain enough measurement results, select a suitable target cell for the UE to access, ensure the handover performance, reduce unnecessary measurements for the UE, and save the processing and power consumption of the UE:

Method 1 for cooperation between neighboring cell L1 measurement and neighboring cell L3 measurement: a neighboring cell measurement threshold is set, and when a trigger condition is met, the UE performs neighboring cell L1 measurement or neighboring cell L3 measurement. The trigger condition of the neighboring cell L1 measurement may be that: if the RSRP quality of the current SpCell (PCell or PSCell) is lower than the neighboring cell measurement threshold, the UE performs neighboring cell L1 measurement; and the trigger condition of the neighboring cell L3 measurement may be that: if the RSRP quality of all LTM cells (for example, SpCell and all LTM candidate cells used for SpCell change) are lower than the neighboring cell measurement threshold, the UE performs neighboring cell L3 measurement. If the quality of the serving cell decreases, it is necessary to select a target cell for the UE and change the serving cell. If only the quality of the SpCell is lower than the neighboring cell measurement threshold, the UE performs neighboring cell L1 measurement, and at this time, the selection scope of the target cell is within the LTM candidate cell set or list. If the quality of all LTM cells is lower than the neighboring cell measurement threshold, the UE performs neighboring cell L3 measurement, and at this time, the selection scope of the target cell is the measurement cells included in the L3 measurement configuration, which may include Inter-RAT cells.

The measurement trigger condition expressed by formulas are as follows:
the trigger condition of neighboring cell L1 measurement: RSRP of SpCell<neighboring cell measurement threshold
the trigger condition of neighboring cell L3 measurement: RSRP of all LTM cells<neighboring cell measurement threshold
where, the RSRP of SpCell refers to SSB RSRP or CSI RSRP of the SpCell, which is configured by the network.

Method 2 for cooperation between neighboring cell L1 measurement and neighboring cell L3 measurement: two neighboring cell measurement thresholds are set, that is, neighboring cell L1 measurement threshold and neighboring cell L3 measurement threshold. When a trigger condition is met, the UE performs neighboring cell L1 measurement or neighboring cell L3 measurement. The trigger condition of the neighboring cell L1 measurement may be that: if the RSRP quality of the current SpCell (PCell or PSCell) is lower than the neighboring cell L1 measurement threshold, the UE performs neighboring cell L1 measurement; and the trigger condition of the neighboring cell L3 measurement may be that: if the RSRP quality of the current SpCell (PCell or PSCell) is lower than the neighboring cell L3 measurement threshold, the UE performs neighboring cell L3 measurement. If the quality of the serving cell decreases, it is necessary to select a target cell for the UE and change the serving cell. If the quality of the current SpCell is lower than the neighboring cell L1 measurement threshold, the UE performs neighboring cell L1 measurement, and at this time, the selection scope of the target cell is within the LTM candidate cell set or list. If the quality of the current SpCell is lower than the neighboring cell L3 measurement threshold, the UE performs neighboring cell L3 measurement, and at this time, the selection scope of the target cell is the measurement cells included in L3 measurement configuration, which may include Inter-RAT cells. The measurement trigger condition expressed by formulas are as follows:
the trigger condition of neighboring cell L1 measurement: RSRP of SpCell<neighboring cell L1 measurement threshold
the trigger condition of neighboring cell L3 measurement: RSRP of SpCell<neighboring cell L3 measurement threshold

If the neighboring cell L1 measurement threshold and the neighboring cell L3 measurement threshold have a same value or use a same measurement threshold, the neighboring cell L1 measurement and the neighboring cell L3 measurement will be triggered at the same time, and the above formula may be simplified as:
the trigger condition of neighboring cell measurement: RSRP of SpCell<neighboring cell measurement threshold

### 3. Change of Measurement Cell in L1 Measurement

In the LTM mode, LTM candidate cells are pre-configured by RRC messages. After the UE performs LTM, in order to avoid RRC reconfiguration, the UE and the network will continue to store the configuration information related to the LTM candidate cells for subsequent LTM handover. With the change of location or cell load status due to UE's mobility, some cells in the LTM candidate cell set or list stored in the UE and the network may not be suitable as LTM candidate cells for the UE. If the UE continues to perform L1 measurement for these LTM candidate cells, the UE's power consumption and processing will be wasted. If these cells and the SpCell are different in frequency, it will cause the UE to perform an inter-frequency L1 measurement, and a certain measurement gap may be required, which may further cause the service transmission of the UE to be interrupted and affect the service transmission quality. Therefore, the present disclosure proposes two methods for change of measurement cells, thereby reducing unnecessary L1 measurement performed by the UE and saving processing and power consumption of the UE.

Method 1 for Change of Measurement Cells:

in Method 1, by changing LTM candidate cells of the UE, unsuitable cells are deleted from the LTM candidate cell set or list to realize the change of the measurement cells, thus avoiding the UE from performing L1 measurement for these cells.

The change of LTM candidate cells for the UE may be based on an L3 measurement result or an L1 measurement result. The specific description is as follows:
(1) Based on an L3 measurement result

When the UE starts to perform L3 measurement, it may use a mode of event-triggered measurement result reporting (event-triggered measurement reporting), that is, when quality of a measured cell meets a condition for event-triggered measurement result reporting, the UE reports a measurement result to the network. Herein, the measurement result reporting may also be called measurement reporting. When the network obtains an L3 measurement result, it selects suitable LTM candidate cells for the UE according to the measurement quality of each cell. If it is necessary to change the current LTM candidate cells, the gNB-CU or gNB will transmit an RRC reconfiguration message to the UE and provide information of the updated LTM candidate cells to the UE and a source cell, and the UE will perform L1 measurement for the updated LTM candidate cells. Type of events for changing the LTM candidate cells and configuration modes of event-triggered measurement reporting may include the following.
Configuration Mode 1: using Event A2 and/or Event A3 and/or Event A5 and the conditions thereof for triggering measurement reporting, that is:
Event A2: the measurement result of a serving cell is lower than a threshold
Entering condition of the event:
Ms+Hys<Thresh
Leaving condition of the event:
Ms−Hys>Thresh
where:
Ms: the measurement result of the serving cell, not taking into account any offset. Serving cells comprise SpCell and SCell. When the measurement result is RSRP, the unit thereof is dBm; when the measurement result is RSRQ (reference signal receiving quality) or RS-SINR (reference signal-signal-to-noise and interference ratio), the unit thereof is dB.
Hys: a hysteresis parameter of the event, which is provided in a measurement configuration. The unit thereof is dB.
Thresh: a threshold parameter of the event, which is provided in a measurement configuration. The unit thereof is the same as that of Ms.
Event A3: the measurement result of a neighboring cell is higher than that of an SpCell (Pcell or PSCell) and exceeds an offset (neighbour becomes offset better than PCell/PSCell).
Entering condition:
Mn+Ofn+Ocn−Hys>Mp+Ofp+Ocp+Off
Leaving condition:
Mn+Ofn+Ocn+Hys<Mp+Ofp+Ocp+Off
where:
Mn: the measurement result of a neighboring cell, not taking into account any offset.
Ofn: a measurement object specific offset of a reference signal of a neighboring cell.
Ocn: a cell specific offset of a neighboring cell, and set to zero if not configured.
Mp: the measurement result of an SpCell, not taking into account any offset.
Ofp: a measurement object specific offset of an SpCell.
Ocp: a cell specific offset of an SpCell, and set to zero if not configured.
Hys: a hysteresis parameter of the event, which is provided in a measurement configuration.
Off: an offset parameter of the event, which is provided in a measurement configuration.
Mn, Mp: when the measurement result is RSRP, the unit thereof is dBm; and when the measurement result is RSRQ or RS-SINR, the unit thereof is dB.
Ofn, Ocn, Ofp, Ocp, Hys, Off: the unit thereof is dB.
Event A5: the measurement result of an SpCell (Pcell or PSCell) is lower than Threshold 1, while the measurement result of a neighboring cell is higher than Threshold 2
Entering condition 1:
Mp+Hys<Thresh1
Entering condition 2:
Mn+Ofn+Ocn−Hys>Thresh2
Leaving condition 1:
Mp−Hys>Thresh1
Leaving condition 2:
Mn+Ofn+Ocn+Hys<Thresh2
where:
Mp: the measurement result of an SpCell, not taking into account any offset.
Mn: the measurement result of a neighboring cell, not taking into account any offset.
Ofn: a measurement object specific offset of a reference signal of a neighboring cell.
Ocn: a cell specific offset of a neighboring cell, and set to zero if not configured.
Hys: a hysteresis parameter of the event, which is provided in a measurement configuration.
Thresh1: a threshold parameter 1 of the event, which is provided in a measurement configuration.
Thresh2: a threshold parameter 2 of the event, which is provided in a measurement configuration.
Mn, Mp: when the measurement result is RSRP, the unit thereof is dBm; and when the measurement result is RSRQ or RS-SINR, the unit thereof is dB.
Ofn, Ocn, Hys: the unit thereof is dB.
Thresh1: the unit thereof is the same as that of Mp.
Thresh2: the unit thereof is the same as that of Mn.

In Configuration Mode 1, when the quality of the SpCell and/or SCell and/or neighboring cell meets the corresponding condition for event-triggered measurement reporting, the network determines whether it is necessary to change the LTM candidate cells and/or the SCell and states/statuses thereof according to the L3 measurement result.
Configuration Mode 2: using updated Event A2 and/or Event A3 and/or Event A5 and the conditions thereof for triggering measurement reporting, and considering the quality of the LTM candidate cells, description of the events and the conditions thereof for triggering measurement reporting are as follows:
Event A2: the measurement result of a serving cell is lower than a threshold. When Event A2 is used to change the LTM candidate cells, it needs to be supplemented that when LTM is configured, the serving cell comprises all the LTM candidate cells in addition to the SpCell and SCell.
Entry condition: Ms+Hys<Thresh
Leaving condition: Ms−Hys>Thresh
where:
Ms: the measurement result of the serving cell, not taking into account any offset. LTM candidate cells are regarded as serving cells, and when LTM is configured, the serving cells comprises all the LTM candidate cells in addition to the SpCell and SCell. When the measurement result is RSRP, the unit thereof is dBm; and when the measurement result is RSRQ or RS-SINR, the unit thereof is dB.
Hys: a hysteresis parameter of the event, which is provided in a measurement configuration. The unit thereof is dB.
Thresh: a threshold parameter of the event, which is provided in a measurement configuration. The unit thereof is the same as that of Ms.
Event A3: the measurement result of a neighboring cell is higher than that of an SpCell (Pcell or PSCell) or an LTM candidate cell and exceeds an offset;
Entering condition:
Mn+Ofn+Ocn−Hys>Mp+Ofp+Ocp+Off
Leaving condition:
Mn+Ofn+Ocn+Hys<Mp+Ofp+Ocp+Off
where:
Mn: the measurement result of a neighboring cell, not taking into account any offset.
Ofn: a measurement object specific offset of a reference signal of a neighboring cell.
Ocn: a cell specific offset of a neighboring cell, and set to zero if not configured.
Mp: the measurement result of the SpCell or LTM candidate cell, not taking into account any offset.
Ofp: a measurement object specific offset of the SpCell or LTM candidate cell.
Ocp: a cell specific offset of the SpCell or LTM candidate cell, and set to zero if not configured.
Hys: a hysteresis parameter of the event, which is provided in a measurement configuration.
Off: an offset parameter of the event, which is provided in a measurement configuration.
Mn, Mp: when the measurement result is RSRP, the unit thereof is dBm; and when the measurement result is RSRQ or RS-SINR, the unit thereof is dB.
Ofn, Ocn, Ofp, Ocp, Hys, Off: the unit thereof is dB.
Event A5: the measurement result of an SpCell (Pcell or PSCell) or LTM candidate cell is lower than Threshold 1, while the measurement result of a neighboring cell is higher than Threshold 2.
Entering condition 1:
Mp+Hys<Thresh1
Entering condition 2:
Mn+Ofn+Ocn−Hys>Thresh2
Leaving condition 1:
Mp−Hys>Thresh1
Leaving condition 2:
Mn+Ofn+Ocn+Hys<Thresh2
where:
Mp: the measurement result of the SpCell or LTM candidate cell, not taking into account any offset.
Mn: the measurement result of a neighboring cell, not taking into account any offset.
Ofn: a measurement object specific offset of a reference signal of a neighboring cell.
Ocn: a cell specific offset of a neighboring cell, and set to zero if not configured.
Hys: a hysteresis parameter of the event, which is provided in a measurement configuration.
Thresh1: a threshold parameter 1 of the event, which is provided in a measurement configuration.
Thresh2: a threshold parameter 2 of the event, which is provided in a measurement configuration.
Mn, Mp: when the measurement result is RSRP, the unit thereof is dBm; and when the measurement result is RSRQ or RS-SINR, the unit thereof is dB.
Ofn, Ocn, Hys: the unit thereof is dB.
Thresh1: the unit thereof is the same as that of Mp.
Thresh2: the unit thereof is the same as that of Mn.

In Configuration Mode 2, when the quality of the SpCell and/or SCell and/or LTM candidate cell and/or neighboring cell meets the corresponding condition for event-triggered measurement reporting, the network determines whether it is necessary to change the LTM candidate cells and/or the SCell and states thereof according to the L3 measurement result.
Configuration Mode 3: setting new event types and conditions for event-triggered measurement reporting, such as setting Event Ax and/or Event Ay and/or Event Az and/or Event Aw and the conditions thereof for triggering measurement reporting, and considering the quality of the LTM candidate cells. Description of the events and the conditions for triggering measurement reporting are as follows:
Event Ax: a measurement result of an LTM candidate cell is lower than a threshold
Entering condition:
Ml+Hys<Thresh
Leaving condition:
Ml−Hys>Thresh
where:
Ml: the measurement result of an LTM candidate cell, not taking into account any offset. When the measurement result is RSRP, the unit thereof is dBm; and when the measurement result is RSRQ or RS-SINR, the unit thereof is dB.
Hys: a hysteresis parameter of the event, which is provided in a measurement configuration. The unit thereof is dB.
Thresh: a threshold parameter of the event, which is provided in a measurement configuration. The unit thereof is the same as that of Ms.
Event Ay: the measurement result of a neighboring cell is higher than that of an LTM candidate cell and exceeds an offset.
Entering condition:
Mn+Ofn+Ocn−Hys>Ml+Ofl+Ocl+Off
Leaving condition:
Mn+Ofn+Ocn+Hys<Ml+Ofl+Ocl+Off
where:
Mn: the measurement result of a neighboring cell, not taking into account any offset.
Ofn: a measurement object specific offset of a reference signal of a neighboring cell.
Ocn: a cell specific offset of a neighboring cell, and set to zero if not configured.
Ml: the measurement result of an LTM candidate cell, not taking into account any offset.
Ofl: a measurement object specific offset of an LTM candidate cell.
Ocl: a cell specific offset of an LTM candidate cell, and set to zero if not configured.
Hys: a hysteresis parameter of the event, which is provided in a measurement configuration.
Off: an offset parameter of the event, which is provided in a measurement configuration.
Mn, Ml: when the measurement result is RSRP, the unit thereof is dBm; and when the measurement result is RSRQ or RS-SINR, the unit thereof is dB.
Ofn, Ocn, Ofl, Ocl, Hys, Off: the unit thereof is dB.
Event Az: the measurement result of an LTM candidate cell is lower than Threshold 1, while the measurement result of a neighboring cell is higher than Threshold 2.
Entering condition 1:
Ml+Hys<Thresh1
Entering condition 2:
Mn+Ofn+Ocn−Hys>Thresh2
Leaving condition 1:
Ml−Hys>Thresh1
Leaving condition 2:
Mn+Ofn+Ocn+Hys<Thresh2
where:
Ml: the measurement result of an LTM candidate cell, not taking into account any offset.
Mn: the measurement result of a neighboring cell, not taking into account any offset.
Ofn: a measurement object specific offset of a reference signal of a neighboring cell.
Ocn: a cell specific offset of a neighboring cell, and set to zero if not configured.
Hys: a hysteresis parameter of the event, which is provided in a measurement configuration.
Thresh1: a threshold parameter 1 of the event, which is provided in a measurement configuration.
Thresh2: a threshold parameter 2 of the event, which is provided in a measurement configuration.
Mn, Ml: when the measurement result is RSRP, the unit thereof is dBm; and when the measurement result is RSRQ or RS-SINR, the unit thereof is dB.
Ofn, Ocn, Hys: the unit thereof is dB.
Thresh1: the unit thereof is the same as that of Mp.
Thresh2: the unit thereof is the same as that of Mn.
Event Aw: the measurement result of a neighboring cell is higher than that of an LTM candidate cell/or an LTM cell (that is, the measurement quality is higher or better) and exceeds an offset.
Entering condition:
Mn+Ocn−Hys>Ml+Ocl+Off
Leaving condition:
Mn+Ocn+Hys<Ml+Ocl+Off
where:
Mn: the measurement result of a neighboring cell, not taking into account any offset.
Ocn: a cell specific offset of a neighboring cell, and set to zero if not configured.
Ml: the measurement result of an LTM candidate cell, not taking into account any offset.
Ocl: a cell specific offset of an LTM candidate cell, and set to zero if not configured.
Hys: a hysteresis parameter of the event, which is provided in a measurement configuration.
Off: an offset parameter of the event, which is provided in a measurement configuration.
Mn, Ms: when the measurement result is RSRP, the unit thereof is dBm; and when the measurement result is RSRQ or RS-SINR, the unit thereof is dB.
Ocn, Ocl, Hys, Off: the unit thereof is dB.

In Configuration Mode 3, when the quality of the LTM candidate cell and/or neighboring cell meets the corresponding condition for event-triggered measurement reporting, the network determines whether it is necessary to change the LTM candidate cells and/or the SCell and states thereof according to the L3 measurement result.

The network side selects from the above configuration modes, and provides a measurement report configuration of the corresponding configuration mode for the UE. The network may also provide the UE with measurement report configurations of Configuration Mode 1 and Configuration Mode 3 at the same time, which is used to trigger the measurement result reporting of the UE, so that the network may change the LTM candidate cells according to the measurement result.
(2) Based on an L1 measurement result

The gNB-DU or Layer 1 (L1) or Layer 2 (L2) determines the quality of the cells in the current LTM candidate cell set or list according to an L1 measurement result reported by the UE, and determines whether the cells can continue to be applicable as the LTM candidate cells of the UE. The gNB-DU or Layer 1 (L1) or Layer 2 (L2) may, according to the quality of the cells, if the quality of a cell is lower than a set threshold, then the gNB-DU will transmit the L1 measurement result of the cell to the gNB-CU or RRC layer, and the gNB-CU or RRC layer will determines whether to delete the cell from the LTM candidate cell set or list.

Method 2 for Change of Measurement Cells:

In Method 2, by transmitting a control message or information to the UE to indicate whether the UE needs to perform L1 measurement for the LTM candidate cells, the change of the measurement cells is realized, thus avoiding the UE from performing unnecessary L1 measurement.

The network may set a state or measurement indication for each LTM candidate cell and transmit it to the UE through a control message or information. If the state/status of an LTM candidate cell is “Measurement Required”, the UE will perform L1 measurement for the LTM candidate cell after the L1 measurement is triggered; and if the cell state is “Measurement Not Required”, the UE will not perform L1 measurement for the LTM candidate cell after the L1 measurement is triggered. The network may determine the state of an LTM candidate cell according to the quality of the LTM candidate cell or its load status/state. Herein, the current quality of a cell may be obtained through an L1 measurement result. When the state of an LTM candidate cell changes, the network transmits state information of the LTM candidate cell to the UE through a control message or information.

The network may transmit the state information of the LTM candidate cell to the UE through a MAC Control Element (MAC CE) or through a PDCCH. The detailed descriptions of the state of an LTM candidate cell transmitted through a MAC CE and a PDCCH are given below.
Transmitting state information of an LTM candidate cell through a MAC CE FIGS. 3a and 3b respectively show a schematic diagram of a structure of MAC CE for transmitting LTM candidate cell states.

FIG. 3a shows a schematic diagram of a MAC CE for transmitting LTM candidate cell states, which consists of one octet, that is, 8 bits. The MAC CE has a fixed size and contains eight C-fields. The MAC CE is identified by a MAC sub-header with an LCID.

FIG. 3b shows a schematic diagram of a MAC CE for transmitting LTM candidate cell states, which consists of two octets, that is, 16 bits. The MAC CE has a fixed size and contains 32 C-fields. The MAC CE is identified by a MAC sub-header with an LCID.

Herein:
the network configures an LTM cell identification LTMCellIndex for each LTM candidate cell. The value range of the LTM cell identification LTMCellIndex i is 0~maxNrofLTMCell, where maxNrofLTMCell is the maximum number of LTM cells that can be configured. The MAC CEs shown in FIGS. 3a and 3b can indicate the states (i.e., measurement indications) of LTM candidate cells when the maximum number of LTM cells is 8 and 16, respectively.
Ci, if the UE is configured with an LTM candidate cell with an identification of LTMCellIndex i, the Ci field will indicate the state (i.e., measurement indication) of the LTM candidate cell LTMCellIndex i, that is, indicate whether the UE needs to measure LTMCellIndex i; otherwise, the UE may ignore the Ci field. Through the value of the Ci field, whether the UE needs to measure the LTM candidate cell with an identification of LTMCellIndex i is indicated. For example, if the Ci field is set to 1, it indicates that the state of the LTM candidate cell with an identification of LTMCellIndex i is “Measurement Required”, and the UE needs to perform L1 measurement for this cell; and if the Ci field is set to 0, it indicates that the state of the LTM candidate cell with an identification of LTMCellIndex i is “Measurement Not Required”, and the UE does not need to perform L1 measurement for this cell.
Transmitting state information of an LTM candidate cell through a PDCCH

When transmitting the state information of an LTM candidate cell through a PDCCH channel, a new Downlink Control Information (DCI) format may be set for transmitting the state information of the LTM candidate cell, and the DCI format contains bits indicating the state information of the LTM candidate cell; or an existing DCI format is used, and bits indicating the state information of the LTM candidate cell are added into the existing DCI format. By corresponding the positions of the bits indicating the state information of the LTM candidate cell in the DCI format to the LTM candidate cell identifications, values of the bits indicate states/statuses of the LTM candidate cells. For example, herein:
Bit i: corresponding to the LTM cell identification LTMCellIndex i. If the UE is configured with an LTM candidate cell with an identification of LTMCellIndex i, the bit i will indicate the state (i.e., measurement indication) of the LTM candidate cell LTMCellIndex i, that is, indicate whether the UE needs to measure LTMCellIndex i; otherwise, the UE may ignore the bit i. The value range of the LTM cell identification LTMCellIndex i is 0~maxNrofLTMCell, where maxNrofLTMCell is the maximum number of LTM cells that can be configured.
Indicating whether the UE needs to measure the LTM candidate cell with an identification of LTMCellIndex i through the value of bit i. For example,
   Bit i is set to 1, indicating that the state of the LTM candidate cell with an identification of LTMCellIndex i is “Measurement Required”, and the UE needs to perform L1 measurement for this cell;
   Bit i is set to 0, indicating that the state of the LTM candidate cell with an identification of LTMCellIndex i is “Measurement Not Required”, and the UE does not need to perform L1 measurement for this cell.

The present disclosure is further described below with reference to the drawings and specific embodiments. It should be understood that the following embodiments are merely exemplary, and various method steps in various embodiments can be combined with each other to form a new embodiment.

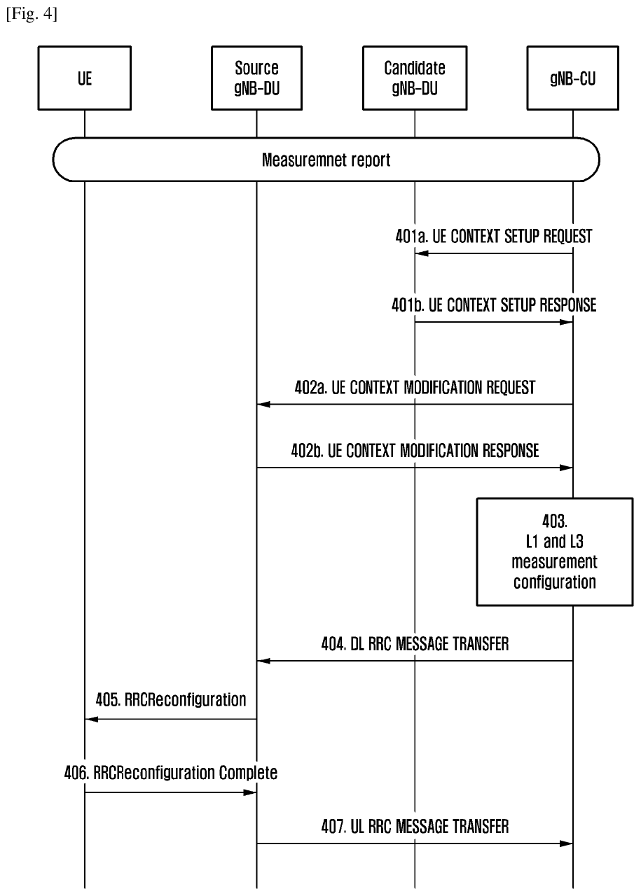

FIG. 4 shows a schematic diagram of an example method according to embodiment 1 of the present disclosure. In the embodiment 1, a method for the network side to perform measurement configuration for the UE is given, so as to indicate the UE to perform L1 and/or L3 measurement based on the corresponding measurement configuration information and report measurement results, thereby reducing the measurement overhead and power consumption of the UE. In the embodiment, measurement configurations of L1 and L3 are both determined by gNB-CU or RRC. For convenience of description, “determining measurement configurations of L1 and L3 by gNB-CU” is uniformly used herein. The specific process is shown in FIG. 4.

In the embodiment, the source gNB-DU and the candidate gNB-DU are connected to the gNB-CU, respectively. LTM candidate cells may be located in the source gNB-DU and/or candidate gNB-DU, respectively. The UE has set up a connection with a cell in the source gNB-DU. When the network decides to trigger a handover in an LTM mode, it will select and configure LTM candidate cells for the UE according to measurement reports provided by the UE (for example, L1 measurement report (or called first measurement report) and/or L3 measurement report (or called second measurement report)).
Step 401a: if an LTM candidate cell selected by the gNB-CU is located in the candidate gNB-DU, the gNB-CU transmits a UE context setup request (UE CONTEXT SETUP REQUEST) message to the candidate gNB-DU, requesting the LTM candidate cell to allocate resources for the UE, and provide configuration information of the LTM candidate cell. The UE context setup request message at least includes an identification of the LTM candidate cell selected for the UE. If carrier aggregation is supported, the UE context setup request message may further include identification information of one or more candidate secondary cells (SCells). The identification information of the SCell may be CGI or SCellIndex, or another identification.
Step 401b: if the candidate gNB-DU agrees to the UE's request for the LTM candidate cell, the candidate gNB-DU transmits a UE context setup response (UE CONTEXT SETUP RESPONSE) message to the gNB-CU, which includes configuration information of the LTM candidate cell of the UE, and may further include one or more candidate secondary cell (SCell) information if carrier aggregation is supported. The SCell information will include at least one of the following:
the identification of SCell, which may be a SCellIndex or another identification;
the state of SCell, which is classified into an activated state or a deactivated state.
Step 402a: if the LTM candidate cell selected by the gNB-CU is located in the source gNB-DU, the gNB-CU transmits a UE context modification request (UE CONTEXT MODIFICATION REQUEST) message to the source gNB-DU, including an identification of the LTM candidate cell selected for the UE. If carrier aggregation is supported, the UE context setup request message may further include identification information of one or more candidate secondary cells (SCells). The identification information of the SCell may be CGI or SCellIndex.
Step 402b: if the source gNB-DU agrees to the UE's request for the LTM candidate cell, the source gNB-DU transmits a UE context modification response (UE CONTEXT MODIFICATION RESPONSE) message to the gNB-CU, which includes configuration information of the LTM candidate cell of the UE, and may further include one or more candidate SCell information if carrier aggregation is supported.
Step 403: the gNB-CU collates the configuration information of all the LTM candidate cells, and performs L1 measurement configuration and L3 measurement configuration for the UE. The L1 measurement configuration and L3 measurement configuration include at least one of the following information.
L1 measurement configuration information, including at least one of the following information:
   cell identification, indicating identification of a cell corresponding to the L1 measurement configuration information or a cell providing the L1 measurement configuration information. The cell identification may be CGI or PCI or other identification;
   L1 measurement object;
   L1 measurement report configuration;
   L1 measurement identification;
   a neighboring cell L1 measurement threshold, for details, see the description in the section “Coordination Between a Neighboring Cell L1 Measurement and Neighboring Cell L3 Measurement”;
   a trigger condition of neighboring cell L1 measurement, for details, see the description in the section “Coordination Between a Neighboring Cell L1 Measurement and Neighboring Cell L3 Measurement”.

After completing the LTM handover, the UE will keep the configuration information related to LTM, and use L1 measurement configuration information of the target cell to perform L1 measurement and report the measurement results. Therefore, L1 measurement configuration information may provide L1 measurement configuration information of multiple cells (including the source cell and/or one or more LTM candidate cells) in the form of a list.
L3 measurement configuration information, including at least one of the following information:
   L3 measurement object;
   L3 measurement report configuration, which at least includes: L3 event types and conditions for event-triggered measurement reporting, which are used for L1 measurement cell change of the UE. For the configuration of the L3 event types and conditions for event-triggered measurement reporting, please refer to the description in Method 1 for Change of Measurement Cells in the section “Change of Measurement Cell in L1 Measurement”.
   L3 measurement identification;
   a neighboring cell L3 measurement threshold, for details, see the description in the section “Coordination Between a Neighboring Cell L1 Measurement and Neighboring Cell L3 Measurement”;
   a trigger condition of neighboring cell L3 measurement, for details, see the description in the section “Coordination Between a Neighboring Cell L1 Measurement and Neighboring Cell L3 Measurement”.
   measurement reporting configuration, including event types and trigger conditions of measurement reporting when using event-triggered measurement reporting. For details, see the description in Method 1 for Change of Measurement Cells.

The gNB-CU will perform the setting of the neighboring cell L1 measurement threshold, neighboring cell L3 measurement threshold, neighboring cell L1 measurement trigger condition and neighboring cell L3 measurement trigger condition, etc., so as to reduce the measurement processing overhead and power consumption of the UE while ensuring the quality of service of the UE is not affected.
Step 404: the gNB-CU transmits a downlink RRC message transfer (DL RRC MESSAGE TRANSFER) message or a UE context modification request (UE CONTEXT MODIFICATION REQUEST) message to the source gNB-DU, indicating to the source gNB-DU that the gNB-CU has configured an LTM handover for the UE. The downlink RRC message transfer message contains at least one of the following information:
an LTM candidate cell set or list, which includes identifications of the LTM candidate cells. For each LTM candidate cell, the network assigns a cell identification LTMCellIndex, or another identification;
L1 measurement configuration information, which, in addition to the information in Step 403, may further include:
   a threshold for LTM candidate cell quality requirement, which is used in the following situations:
      if the RSRP value of a candidate cell is lower than the threshold, the gNB-DU reports a measurement result and/or an identification of the candidate cell to the gNB-CU;
      if the RSRP value of a candidate cell is lower than the threshold, the gNB-DU will indicate that the UE does not need to perform L1 measurement for the candidate cell.
an RRC reconfiguration (RRCReconfiguration) message transmitted to the UE, which is provided in the form of a container and includes at least one of the following information:
   an LTM candidate cell set or list, which includes identifications of the LTM candidate cells. For each LTM candidate cell, the network assigns a cell identification LTMCellIndex, or another identification;
   resource configuration information of an LTM candidate cell, which at least includes cell group configuration information (CellGroupConfig). If Carrier Aggregation (CA) is supported, and the network has configured at least one SCell for the UE, then the CellGroupConfig will include one or more candidate SCell information, which will include at least one of the following:
      the identification of SCell, which may be a SCellIndex or another identification;
      the state of SCell, which is classified into an activated state or a deactivated state;
   L1 measurement configuration information, as detailed in Step 403;
   L3 measurement configuration information, as detailed in Step 403.

In Step 405, the source gNB-DU transmits an RRC reconfiguration (RRCReconfiguration) message to the UE, which includes LTM configuration related information and L1 and L3 measurement configurations. Herein, the RRC reconfiguration message may also be referred to as a first message. The reconfiguration message is transmitted by the gNB-CU to the source gNB-DU in the form of an RRC container, and transmitted by the source gNB-DU to the UE. Contents contained in the message are described in the RRC reconfiguration message in Step 404, and will not be repeated here. The UE determines to perform a neighboring cell L1 measurement and/or a neighboring cell L3 measurement according to the neighboring cell L1 measurement threshold, neighboring cell L3 measurement threshold, neighboring cell L1 measurement trigger condition and neighboring cell L3 measurement trigger condition in the received L1 and L3 measurement configuration information, for details, see the description in “Coordination Between a Neighboring Cell L1 Measurement and Neighboring Cell L3 Measurement”.
Step 406: the UE transmits an RRC reconfiguration complete (RRCReconfiguration Complete) message to the source gNB-DU, indicating that the UE has completed the LTM configuration.
Step 407: the target gNB-DU transmits an uplink RRC message transfer (UL RRC MESSAGE TRANSFER) message to the gNB-CU, which includes the RRCReconfig-urationComplete message transmitted by the UE to the gNB-CU.

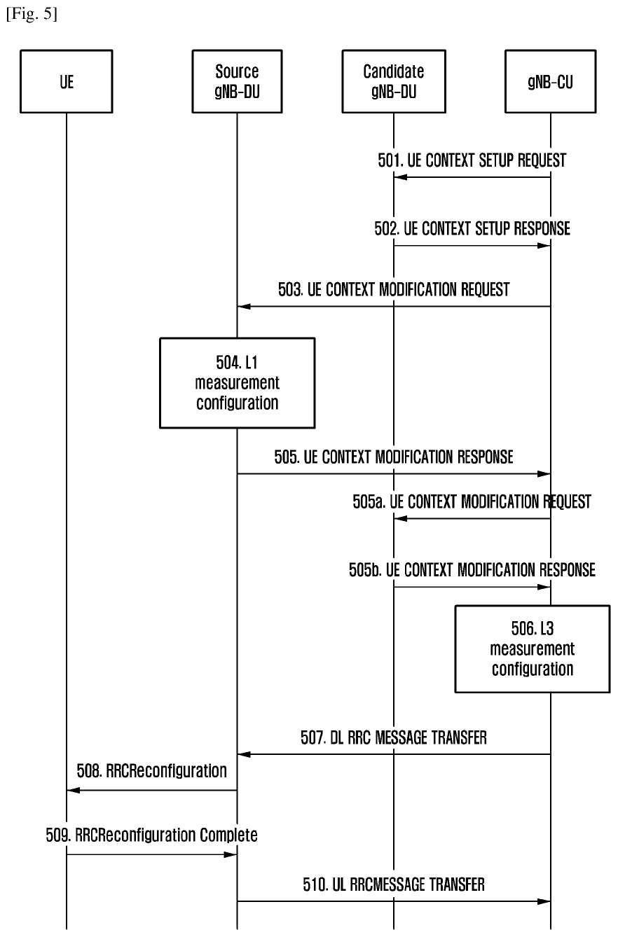

FIG. 5 shows a schematic diagram of an example method according to embodiment 2 of the present disclosure. In the embodiment 2, another method for the network side to perform measurement configuration for the UE is given, so as to indicate the UE to perform L1 and/or L3 measurement based on the corresponding measurement configuration information and report measurement results, thereby reducing the measurement overhead and power consumption of the UE. In the embodiment, the measurement configuration of L1 is determined by the source cell (PCell or PSCell) or the source gNB-DU, and the measurement configuration of L3 is determined by the gNB-CU or RRC.

Herein, the source gNB-DU and the candidate gNB-DU are connected to the gNB-CU respectively. LTM candidate cells may be located in the source gNB-DU and/or candidate gNB-DU, respectively. The UE has been connected to a cell in the source gNB-DU. When the network decides to trigger a handover in an LTM mode, it will select and configure LTM candidate cells for the UE according to measurement reports provided by the UE.
Steps 501-502 are the same as Steps 401a-401b, and will not be repeated here.
Step 503: the gNB-CU transmits a UE context modification request (UE CONTEXT MODIFICATION REQUEST) message to the source gNB-DU. If the L1 measurement configuration is provided by the source cell (or the source gNB-DU), the gNB-CU will transmit indication information to the source gNB-DU and provide candidate cell list information configured for the UE on other candidate gNB-DUs to the source gNB-DU. The UE context modification request message includes at least one of the following information:
the identification of an LTM candidate cell requested to be set up, which is the identification of an LTM candidate cell requested to be set up on the source gNB-DU, and may be a PhysCellId, a CGI or a Cell Index.
L1 measurement configuration indication, which is used to indicate the gNB-DU to provide L1 measurement configuration to support LTM handover.
information of an LTM candidate cell set or list, which is information of an LTM candidate cell list configured for the UE on other candidate gNB-DUs. It includes cell identifications and frequency information of the candidate cells, where the cell identification may be a PhysCellId, a CGI or a Cell Index.
Step 504: if the identification of an LTM candidate cell requested to be set up is received in Step 503, the source gNB-DU needs to configure an LTM candidate cell for the UE according to the cell identification. After the source gNB-DU determines that it is by the source gNB-DU to perform L1 measurement configuration for the UE through Step 503, it may determine the L1 measurement configuration for the UE according to the information of LTM candidate cells and UE capabilities, and transmit it to the gNB-CU.
Step 505: the source gNB-DU transmits a UE context modification response (UE CONTEXT MODIFICATION RESPONSE) message to the gNB-CU, including at least one of the following information:
L1 measurement object.
L1 measurement report configuration.
L1 measurement identification.
a neighboring cell L1 measurement threshold, for details, see the description in the section “Coordination Between a Neighboring Cell L1 Measurement and Neighboring Cell L3 Measurement”.
a trigger condition of neighboring cell L1 measurement, for details, see the description in the section “Coordination Between a Neighboring Cell L1 Measurement and Neighboring Cell L3 Measurement”.
an LTM candidate cell set or list, which includes cell identification and frequency information of the candidate cells. The cell identification may be a PhysCellId, a CGI or a Cell Index. The LTM candidate cell set or list includes the LTM candidate cell set or list of the UE configured on other candidate gNB-DUs obtained in Step 503 and the LTM candidate cells of the UE configured in the source gNB-DU.

If L1 measurement related parameters are configured by the gNB-DU for UE, steps 505a and 505b need to be performed, and the gNB-CU indicates a candidate gNB-DU to configure L1 measurement configuration information for the UE. Through steps 505a-505b, the gNB-CU obtains L1 measurement configuration information provided by each LTM candidate cell for the UE.
Step 505a: the gNB-CU transmits a UE context modification request (UE CONTEXT MODIFICATION REQUEST) message to a candidate gNB-DU. If the L1 measurement configuration is provided by the gNB-DU, the gNB-CU will transmit indication information to the candidate gNB-DU, and provide all candidate cell list information of the UE (including all candidate gNB-DUs and LTM candidate cells configured by the source gNB-DU for the UE) to the candidate gNB-DU. The UE context modification request message includes at least one of the following information:
L1 measurement configuration indication, which is used to indicate the gNB-DU to provide L1 measurement configuration to support LTM handover.
information of an LTM candidate cell set or list, which includes information of all LTM candidate cells of the UE. The information includes cell identifications and frequency information of the candidate cells, where the cell identification may be a PhysCellId, a CGI or a Cell Index.
Step 505b: the candidate gNB-DU transmits a UE context modification response (UE CONTEXT MODIFICATION RESPONSE) message to the gNB-CU, which includes L1 measurement configuration related information. The message includes at least one of the following information:
L1 measurement object.
L1 measurement report configuration.
L1 measurement identification.
a neighboring cell L1 measurement threshold, for details, see the description in the section “Coordination Between a Neighboring Cell L1 Measurement and Neighboring Cell L3 Measurement”.
a trigger condition of neighboring cell L1 measurement, for details, see the description in the section “Coordination Between a Neighboring Cell L1 Measurement and Neighboring Cell L3 Measurement”.
an LTM candidate cell set or list, which includes cell identification and frequency information of the candidate cells. The cell identification may be a PhysCellId, a CGI or a Cell Index. The LTM candidate cell set or list includes all the LTM candidate cells of the UE obtained in Step 505a.
Step 506: the gNB-CU collates the configuration information (including L1 measurement configuration information, see the description of L1 measurement configuration information in Step 403) of all the LTM candidate cells, performs L3 measurement configuration for the UE, and assigns cell identification LTMCellIndex to the LTM candidate cells. For the L3 measurement configuration information, please refer to the description of L3 measurement configuration information in Step 403, which will not be repeated here.
Step 507: the gNB-CU transmits a downlink RRC message transfer (DL RRC MESSAGE TRANSFER) message to the source gNB-DU, indicating to the source gNB-DU that the gNB-CU has configured an LTM handover for the UE. And it transmits resource configuration information of the LTM candidate cells, L1 measurement configuration information and L3 measurement configuration information and so on to the UE. The downlink RRC message transfer message includes at least one of the following information:
an RRC reconfiguration (RRCReconfiguration) message transmitted to the UE, which is provided in the form of a container and includes at least one of the following information:
   an LTM candidate cell set or list, which includes identifications of the LTM candidate cells. For each LTM candidate cell, the network assigns a cell identification LTMCellIndex;
   resource configuration information of an LTM candidate cell, as detailed in Step 404;
   L1 measurement configuration information, as detailed in Step 403;
   L3 measurement configuration information, as detailed in Step 403.

Steps 508-510 and 405-407 are the same, and will not be repeated here.

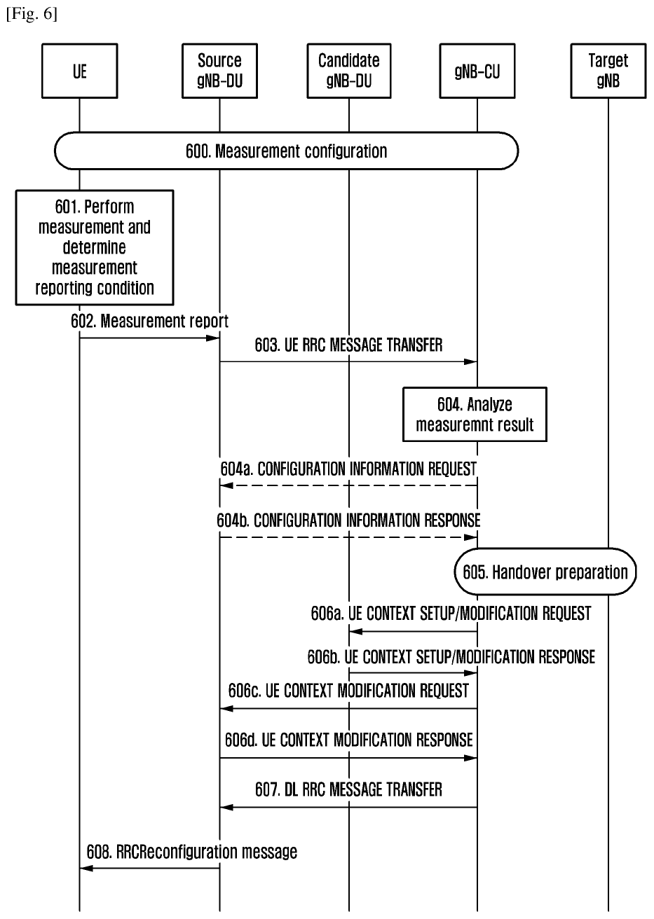

FIG. 6 shows a schematic diagram of an example method according to embodiment 3 of the present disclosure. In the embodiment 3, an L1 measurement cell change process is given.

This embodiment shows that the network triggers the change of L1 measurement cells and/or the update of SCell information according to an L3 measurement result reported by the UE, and the SCell information may be information of the current serving SCell and/or information of a candidate SCell. The specific process is shown in FIG. 6.
Step 600: the network performs measurement configuration for the UE, including L1 measurement configuration and/or L3 measurement configuration. The specific process and contents are shown in embodiments 1 and 2. The L3 measurement configuration includes event types and event-triggered measurement reporting conditions for event reporting based L3 measurement, which is used to change LTM candidate cells of the UE.
Step 601: the UE performs measurement according to the measurement configurations of L1 and/or L3 received in Step 600, and determines whether a measurement result meets a measurement reporting condition. When an event-triggered measurement reporting condition is met, Step 602 will be performed, and a measurement report (for example, a second measurement report or L3 measurement report) will be transmitted to the network for measurement reporting. See “Method 1 for Change of Measurement Cells” for details of the event types and event-triggered measurement reporting conditions for event reporting based L3 measurement.
Step 602: the UE transmits a measurement report (MeasurementReport) to the source gNB-DU and transmits an L3 measurement result to the network.
Step 603: the source gNB-DU transmits an uplink RRC message transfer (UL RRC MESSAGE TRANSFER) message to the gNB-CU, including the MeasurementReport message transmitted by the UE to the gNB-CU.
Step 604: the gNB-CU analyzes the received measurement result of the UE to determine whether it is necessary to
change the LTM candidate cells of the UE, or whether it is necessary to indicate the UE to perform an L3 handover (including a normal handover or a conditional handover), change the serving cell, or change the serving SCell. If the resource configuration information of the LTM candidate cell includes candidate SCell information, the candidate SCell information may be updated according to the measurement results, including deletion and/or addition of SCell, to form updated candidate SCell identifications (including one or more candidate SCell identifications). Or update the serving SCell information according to the measurement results, including deletion and/or addition of the serving SCell, to form updated serving SCell identifications (including one or more serving SCell identifications).

If the gNB-CU determines to change the LTM candidate cells of the UE, the gNB-CU selects suitable LTM candidate cells for the UE according to measurement results, and updates an LTM candidate cell set or list of the UE, thus realizing change of measurement cells. Subsequent processes will perform Steps 606-608.

If the gNB-CU determines that the UE needs to perform an L3 handover, the gNB-CU selects a target cell for the UE according to the measurement results. If the target cell is located in another gNB, that is, a target gNB, then Step 605 will be performed first, and then Steps 607-608 will be performed.

Before performing step 605, the source gNB-CU may need to obtain the current communication context information of the UE from the source gNB-DU, for the target cell of L3 handover (the target cell is located in the target gNB) to perform resource configuration for the UE, and 604a-604b needs to be performed. If the UE is triggered to perform LTM handover at this time, the information or message fed back by the source gNB-DU to the gNB-CU will indicate that the acquisition of UE configuration information is failed, and indicate that the failure cause is that the UE is performing an LTM handover to update the serving cell. If the UE is to be triggered of an LTM handover at this time, and the information or message fed back to the gNB-CU by the source gNB-DU does not provide gNB-DU configuration information related to the UE, it will indicate that the failure cause is that the UE will perform an LTM handover to update the serving cell. If the source gNB-DU has not triggered or does not prepare to trigger an LTM handover to change the service cell of the UE at this time, the source gNB-DU provides gNB-DU configuration information related to the UE to the gNB-CU. According to the information obtained from the source gNB-DU, the gNB-CU decides whether to stop triggering L3 handover, or indicates the target cell to provide the UE with L3 handover configuration information of the candidate target cells in a full configuration mode. Therefore, it can be avoided that the UE cannot correctly parse the L3 handover configuration information due to the wrong reference cell configuration information. Herein:
Step 604a: the gNB-CU transmits a message to the gNB-DU where the UE service cell is located, requesting the current configuration information of the UE. The message may be a newly defined configuration information request message, or a UE context modification request (UE Context Modification Request) message, or other messages. The configuration information acquisition request message includes at least one of the following information:
gNB-DU Configuration Query indication, which is used to indicate to query the gNB-DU configuration information related to the UE, that is, indicate the gNB-DU to provide gNB-DU configuration information related to the UE (or gNB-DU configuration information of the UE in the current serving cell, or configuration information of the UE in the gNB-DU).
Cause, which is used to indicate the cause for querying gNB-DU configuration. The cause may be “L3 handover preparation”, or “security key update”, or other causes.

The gNB-DU can determine the purpose of the gNB-CU to query the gNB-DU configuration through the received gNB-DU configuration query indication and/or cause. When the purpose of the gNB-CU to query the gNB-DU configuration is to perform L3 handover preparation or security key update, the gNB-DU will transmit feedback message to the gNB-CU according to the current situation of triggering LTM handover:
If the gNB-DU has transmitted an LTM handover command to the UE, the gNB-DU transmits information or a message to the gNB-CU, indicating that the serving cell of the UE is changed (or updated), thereby avoiding the gNB-CU from transmitting L3 handover request message to the target gNB-CU (or target gNB or target base station) for L3 handover preparation, reducing unnecessary signaling transmission overhead between gNB-CUs and reducing the conflict between LTM handover and L3 handover.
If the gNB-DU prepares to transmit an LTM handover command to the UE, the gNB-DU transmits information or a message to the gNB-CU, indicating that the serving cell of the UE will be changed, thereby avoiding the gNB-CU from transmitting L3 handover request message to the target gNB-CU (or target gNB or target base station) for L3 handover preparation, reducing unnecessary signaling transmission overhead between gNB-CUs and reducing the conflict between LTM handover and L3 handover.
if the gNB-DU does not transmit an LTM handover command to the UE or does not prepare to transmit an LTM handover command to the UE, the gNB-DU transmits gNB-DU configuration information related to the UE to the gNB-CU, while temporarily stops or stops the trigger of the LTM handover.
Step 604b: the gNB-DU transmits a feedback message to the gNB-CU. The details are as follows:
If the UE is triggered to perform an LTM handover (that is, the gNB-DU has transmitted an LTM handover command to the UE), the gNB-DU feeds back to the gNB-CU the failure in obtaining the UE configuration information and the failure cause. The feedback message may be a newly defined configuration information response message, or a UE Context Modification Response message or a UE Context Modification Failure message, or other messages. The configuration information indication message at least includes one of the following information:
identification of the requested target cell, corresponding to the identification of the serving cell of the UE in step 604a, that is, identification of the cell requesting to query gNB-DU configuration information. The cell identification may be CGI, PCI, or other identifications.
gNB-DU configuration query failure indication, which is used to indicate that the gNB-DU cannot provide gNB-DU configuration information related to the UE.
RRC information transmitted from DU to CU (DU to CU RRC information), including gNB-DU configuration information related to the UE, that is, gNB-DU configuration information of the UE in the current serving cell.
Failure Cause, indicating the cause why gNB-DU configuration information acquisition is failed. The failure cause may be that the LTM handover has been triggered, or other causes.
target cell identification, which indicates the target cell identification for the UE to perform an LTM handover if the gNB-DU triggers the LTM handover. The target cell identification may be CGI and/or Physical Cell ID and/or other cell identifications.

Herein, it can be indicated that the gNB-DU cannot provide the gNB-DU configuration information related to the UE in one of the following two ways, that is, gNB-DU configuration information acquisition failure:
Method 1: the feedback message contains “gNB-DU configuration query failure indication”, which is called an explicit indication method.
Method 2: the feedback message does not contain “DU to CU RRC information”, which is called an implicit indication method.
If the gNB-DU prepares to trigger the UE to perform an LTM handover (that is, preparing to transmit an LTM handover command to the UE), the source gNB-DU provides the gNB-CU with an indication of preparation to trigger the LTM handover and/or provides configuration information of the UE. The feedback message is a newly defined configuration information response message, or a UE Context Modification Response message, or a UE Context Modification Failure message, or other messages. The configuration information indication message at least includes one of the following information:
identification of the requested target cell, corresponding to the identification of the serving cell of the UE in step 604a, that is, identification of the cell requesting to query gNB-DU configuration information. The cell identification may be CGI, PCI, or other identifications.
gNB-DU configuration query failure indication, which is used to indicate that the gNB-DU cannot provide gNB-DU configuration information related to the UE.
RRC information transmitted from DU to CU (DU to CU RRC information), including gNB-DU configuration information related to the UE, that is, gNB-DU configuration information of the UE in the current serving cell.
indication of preparation to trigger an LTM handover, which is used for the gNB-DU to indicate to the gNB-CU that the gNB-DU prepares to trigger an LTM handover.

If the gNB-CU prepares to perform an L3 handover, the gNB-CU transmits the received gNB-DU configuration information of the UE in the current serving cell to the target gNB-CU (or the target base station), and the target gNB-CU will generate L3 handover configuration information of the target cell according to the configuration information. The L3 handover target cell/target base station may adopt an incremental configuration mode (delta configuration mode) to form L3 handover configuration information of the target cell based on the configuration of the current serving cell of the UE). Since the L3 handover configuration information may be received after the UE updates the serving cell, and the L3 handover configuration information is formed based on the previous serving cell, the L3 handover configuration information received by the UE would be wrong. Therefore, if the configuration information indication message contains an indication of preparation to trigger an LTM handover, which indicates that the gNB-DU prepares to trigger an LTM handover to change the service cell of the UE, the gNB-CU will stop transmitting a request for L3 handover preparation to the target cell/target base station, or indicate the target base station/target cell to configure in a full configuration mode (full configuration mode) and provide L3 handover configuration information of the target cell, thereby avoiding the generation of wrong L3 handover configuration information, avoiding the transmission of wrong L3 handover configuration information, and reducing unnecessary signaling transmission overhead between gNB-CUs.
target cell identification, which indicates the identification of the target cell that the UE prepares to handover to if the gNB-DU prepares to trigger an LTM handover. The target cell identification may be CGI and/or Physical Cell ID and/or other cell identifications.
Failure Cause, indicating the cause why gNB-DU configuration information acquisition is failed. The failure cause may be preparation to trigger an LTM handover, or other causes. If the gNB-DU does not provide gNB-DU configuration information related to the UE, the failure cause will be provided. Or if the feedback message uses the UE context modification failure message, the failure cause would be included.

Herein, it can be indicated that the gNB-DU cannot provide the gNB-DU configuration information related to the UE in one of the following two ways, that is, gNB-DU configuration information acquisition failure:
Method 1: the feedback message contains “gNB-DU configuration query failure indication”, which is called an explicit indication method.
Method 2: the feedback message does not contain “DU to CU RRC information”, which is called an implicit indication method.
If the gNB-DU does not trigger an LTM handover or does not prepare to trigger an LTM handover at this time, the source gNB-DU will provide the configuration information of the UE to the gNB-CU. The feedback message may be a UE Context Modification Response message, or other messages. The configuration information indication message at least includes one of the following information:
identification of the requested target cell, corresponding to the identification of the serving cell of the UE in step 604a, that is, identification of the cell requesting to query gNB-DU configuration information. The cell identification may be CGI, PCI, or other identifications.
RRC information transmitted from DU to CU (DU to CU RRC information), including gNB-DU configuration information related to the UE, that is, gNB-DU configuration information of the UE in the current serving cell.

Step 605, handover preparation: the gNB-CU selects a target cell for the UE, and exchanges messages with a target gNB to which the target cell belongs, so as to complete configuration for the UE in the target cell and prepare for the handover of the UE to the target cell.

Step 606a-b, the gNB-CU indicates the candidate gNB-DU to add or release LTM candidate cells of the UE, so as to realize the change of the LTM candidate cell set or list of the UE and/or update the candidate SCell information. The gNB-CU provides candidate SCell identifications (including one or more candidate SCell identifications) updated in Step 604 to the candidate gNB-DU, and the candidate gNB-DU sets states for the candidate SCells, to form updated candidate SCell information and transmit it to the gNB-CU in Step 606b. This process is realized by a UE context setup or modification process. If the candidate gNB-DU has not configured LTM candidate cells for the UE, this step uses a UE context setup process, Step 606a uses a UE context setup request message, and Step 606b uses a UE context setup response message. If the candidate gNB-DU has configured LTM candidate cells for the UE, this step is realized by using a UE context modification process, Step 606a uses a UE context modification request message, and Step 606b uses a UE context modification response message.

Herein, the messages in Step 606a includes identifications of the LTM candidate cells of the UE to be set up or deleted, and the identification of a cell may be a PhysCellId, a Cell Index, a CGI or a LTMCellIndex.
Steps 606c and 606d: the gNB-CU indicates the source gNB-DU to add or release LTM candidate cells of the UE, so as to realize change of an LTM candidate cell set or list of the UE, and/or update the candidate SCell information and/or update the serving SCell information. The gNB-CU provides the candidate SCell identifications (including one or more candidate SCell identifications) and/or serving SCell identification updated in Step 604 to the source gNB-DU, which sets states for the candidate SCells and/or serving SCell to form updated candidate SCell information and/or updated serving SCell information, and transmits it to the gNB-CU in Step 606d. This process is realized by a UE context modification process. Herein, the UE context modification request message in Step 606c includes identifications of the LTM candidate cells of the UE to be set up or deleted, and/or updated candidate SCell identifications and/or the updated serving SCell identification. The identification of a cell may be a PhysCellId, a Cell Index, a CGI or a LTMCellIndex, or another identification. The identification of the SCell may be a SCellIndex or another identification.
Step 607: the gNB-CU transmits a downlink RRC message transfer (DL RRC MESSAGE TRANSFER) message or a UE context modification request (UE CONTEXT MODIFICATION REQUEST) message to the source gNB-DU.

If the gNB-CU determines to change LTM candidate cells of the UE to realize the change of measurement cells, the downlink RRC message transfer message includes at least one of the following information:
an LTM candidate cell set or list, which includes identifications of the LTM candidate cells. For each LTM candidate cell, the network assigns a cell identification LTMCellIndex, or another identification;
L1 measurement configuration information, as detailed in Step 403;
an RRC reconfiguration (RRCReconfiguration) message transmitted to the UE, which is provided in the form of a container and includes at least one of the following information:
   L an LTM candidate cell set or list, which includes identifications of the LTM candidate cells. For each LTM candidate cell, the network assigns a cell identification LTMCellIndex, or another identification;
   resource configuration information of an LTM candidate cell, as detailed in Step 404. Herein, if candidate SCell information is included, the candidate SCell information is the candidate SCell information obtained in Steps 606b and/or 606d;
   L1 measurement configuration information, as detailed in Step 403;
   L3 measurement configuration information, as detailed in Step 403.
   resource configuration information of the current serving cell group, which at least includes the current serving SCell information, and the SCell information will include at least one of the following:
      the identification of SCell, which may be a SCellIndex or another identification;
      the state of SCell, which is classified into an activated state or a deactivated state.

If the gNB-CU determines that the UE needs to perform an L3 handover, the downlink RRC message transfer message includes at least one of the following information:
an indication to stop LTM, which is used to indicate the source gNB-DU to stop using LTM to change the serving cell of the UE.
an RRC reconfiguration (RRCReconfiguration) message transmitted to the UE, which is provided in the form of a container and includes at least one of the following information:
   the identification of an L3 handover target cell, which may be a PhysCellId, a Cell Index or a CGI.
   resource configuration information of the L3 handover target cell.
Step 608: the source gNB-DU transmits an RRC reconfiguration (RRCReconfiguration) message to the UE. Herein, the RRC reconfiguration message may also be referred to as a second message. The reconfiguration message is transmitted by the gNB-CU to the source gNB-DU in the form of an RRC container, and transmitted by the source gNB-DU to the UE. Contents included in the message are described in the RRC reconfiguration message in Step 607, and will not be repeated here. According to the contents of the RRC reconfiguration message, the UE will determine whether to perform the configuration update of the LTM candidate cells or to perform an L3 handover. If it is to perform the configuration update of the LTM candidate cells, the UE will perform measurement according to the updated LTM candidate cells, thus avoiding the processing overhead and energy loss caused by the UE performing measurement on LTM candidate cells with poor quality.

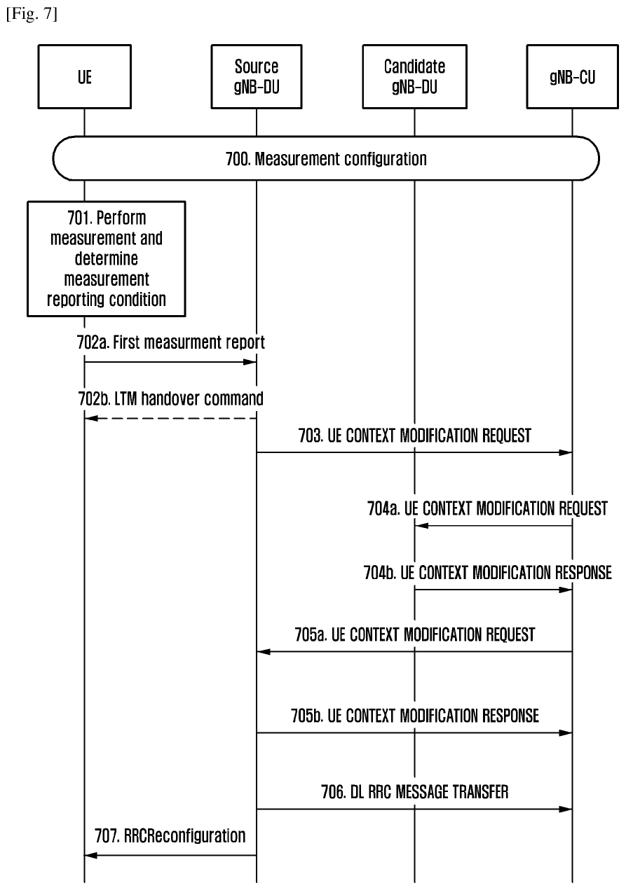

FIG. 7 shows a schematic diagram of an example method according to embodiment 4 of the present disclosure. In the embodiment 4, another L1 measurement cell change process is given.

This embodiment shows that the network triggers the change of L1 measurement cells according to an L1 measurement result reported by the UE. The specific process is shown in FIG. 7.
Step 700: the network performs measurement configuration for the UE, including L1 measurement configuration and/or L3 measurement configuration. The specific process and contents are shown in embodiments 1 and 2. The L3 measurement configuration includes event types and event-triggered measurement reporting conditions for event reporting based L3 measurement, which is used to change LTM candidate cells of the UE.
Step 701: the UE performs measurement according to the measurement configurations of L1 and/or L3 received in Step 700, and determines whether a measurement result meets a measurement reporting condition. When an L1 measurement reporting condition is met, Step 702a will be performed, and an L1 measurement report will be transmitted to the network.
Step 702a: the UE transmits a first measurement report, or be referred to as an L1 measurement report, to the source gNB-DU, to transmit an L1 measurement result to the source gNB-DU. The source gNB-DU evaluates the quality of the serving cell and/or LTM candidate cells according to the L1 measurement report. If the gNB-DU determines that cell handover is required, it may transmit an LTM handover command or handover indication (also called a third message) to the UE in Step 702b, which may include the identification of the target cell for handover. If it is determined that there are LTM candidate cells whose quality is lower than a threshold, the source gNB-DU will perform Step 703, and transmit identifications of the cells whose L1 measurement results and/or quality is lower than the threshold (for example, it may be called a third measurement report) to the gNB-CU, suggesting the gNB-CU deleting the cells whose quality is lower than the threshold from the LTM candidate cell set or list of the UE, where the cell identifications may be provided in the form of a list. Herein the threshold is included in L1 measurement configuration information transmitted by the gNB-CU to the gNB-DU, and for details, please see “a threshold for LTM candidate cell quality requirement” in Step 404.
Step 703: the source gNB-DU transmits a UE context modification required (UE CONTEXT MODIFICATION REQUIRED) message to the gNB-CU, indicating to the gNB-CU that the quality of the LTM candidate cells is lower than the threshold. The message includes at least one of the following information:
a list of identifications of LTM candidate cells whose quality is lower than a threshold, where the cell identification may be a PhysCellId or a Cell Index, a CGI, a LTMCellIndex or another identification.
an L1 measurement result, RSRP values of LTM candidate cells and/or a neighboring cell measurement result measured by UE. The RSRP may be SSB RSRP, or CSI RSRP, or an RSRP value of another signal.

The gNB-CU determines the LTM candidate cells that need to be deleted according to the received cell identifications and/or L1 measurement result, and if the LTM candidate cell that needs to be deleted belongs to the candidate gNB-DU, Steps 704a and 704b are performed; and if the LTM candidate cell that needs to be deleted belongs to the source gNB-DU, Steps 705a and 705b are performed.

If the resource configuration information of the LTM candidate cell includes candidate SCell information, the gNB-CU may update the candidate SCell information and/or serving SCell according to the received cell identifications and/or L1 measurement result, including deletion and/or addition of SCell, to form updated candidate SCell identifications (including one or more candidate SCell identifications) and/or updated serving SCell identifications (including one or more serving SCell identifications).
Step 704a: the gNB-CU transmits a UE context modification request message to the candidate gNB-DU, which includes identifications of the cells requested to be deleted, indicating the candidate gNB-DU to delete the cells from the LTM candidate cell list of the UE, and release the resources allocated to the UE in the cell. It may further include updated candidate SCell identifications.
Step 704b: the candidate gNB-DU transmits a UE context modification response message to the gNB-CU, indicating that cells requested to be deleted have been deleted from the LTM candidate cell list. If updated candidate SCell identifications are received in Step 704a, the candidate gNB-DU needs to set states for the updated candidate SCells to form new candidate SCell information and transmit it to the gNB-CU.
Step 705a: the gNB-CU transmits a UE context modification request message to the source gNB-DU, which includes identifications of the cells requested to be deleted, indicating the candidate gNB-DU to delete the cells from the LTM candidate cell list of the UE, and release the resources allocated to the UE in the cell. It may further include updated candidate SCell identifications and/or updated serving SCell identifications.
Step 705b: the source gNB-DU transmits a UE context modification response message to the gNB-CU, indicating that cells requested to be deleted have been deleted from the LTM candidate cell list. If updated candidate SCell identifications are received in Step 705a, the source gNB-DU needs to set states for the updated candidate SCells to form new candidate SCell information and transmit it to the gNB-CU. If updated serving SCell identifications are received in Step 705a, the source gNB-DU needs to set states for the updated serving SCells to form new serving SCell information and transmit it to the gNB-CU.
Step 706: the gNB-CU transmits a downlink RRC message transfer (DL RRC MESSAGE TRANSFER) message or a UE context modification request (UE CONTEXT MODIFICATION REQUEST) message to the source gNB-DU to provide updated LTM candidate cell information. The downlink RRC message transfer message includes at least one of the following information:
an LTM candidate cell set or list, which includes identifications of the LTM candidate cells. For each LTM candidate cell, the network assigns a cell identification LTMCellIndex;
L1 measurement configuration information, as detailed in Step 403;
an RRC reconfiguration (RRCReconfiguration) message transmitted to the UE, which is provided in the form of a container and includes at least one of the following information:
   an LTM candidate cell set or list, which includes identifications of the LTM candidate cells. For each LTM candidate cell, the network assigns a cell identification LTMCellIndex;
   resource configuration information of an LTM candidate cell, as detailed in Step 404. Herein, if candidate SCell information is included, the candidate SCell information is the candidate SCell information obtained in Steps 704b and/or 705b;
   L1 measurement configuration information, as detailed in Step 403;
   L3 measurement configuration information, as detailed in Step 403;
   resource configuration information of the current serving cell group, which at least includes the current serving SCell information, and the SCell information will include at least one of the following:
      the identification of SCell, which may be a SCellIndex or another identification;
      the state of SCell, which is classified into an activated state or a deactivated state.
Step 707: the source gNB-DU transmits an RRC reconfiguration (RRCReconfiguration) message to the UE, which is used to indicate the UE to change measurement cells. The reconfiguration message is transmitted by the gNB-CU to the source gNB-DU in the form of an RRC container, and transmitted by the source gNB-DU to the UE. Contents included in the message are described in the RRC reconfiguration message in Step 706, and will not be repeated here. The UE will perform measurement according to the updated LTM candidate cells, thus avoiding the processing overhead and energy loss caused by the UE performing measurement on LTM candidate cells with poor quality.

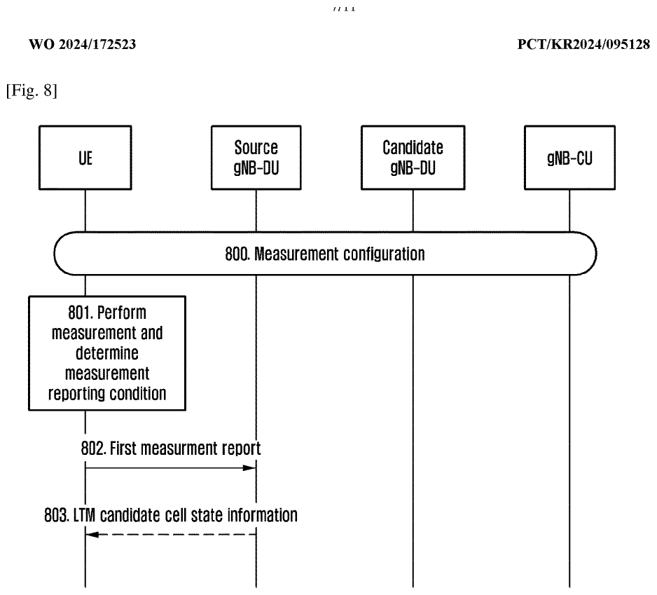

FIG. 8 shows a schematic diagram of an example method according to embodiment 5 of the present disclosure. In the embodiment 6, another L1 measurement cell change process is given.

This embodiment shows that the network triggers the change of L1 measurement cells according to an L1 measurement result reported by the UE. The specific process is shown in FIG. 8.
Step 800: the network performs measurement configuration for the UE, including L1 measurement configuration and/or L3 measurement configuration. The specific process and contents are shown in embodiments 1 and 2. The L3 measurement configuration includes event types and event-triggered measurement reporting conditions for event reporting based L3 measurement, which is used to change LTM candidate cells of the UE.
Step 801: the UE performs measurement according to the measurement configurations of L1 and/or L3 received in Step 800, and determines whether a measurement result meets a measurement reporting condition. When an L1 measurement reporting condition is met, Step 802 will be performed.
Step 802: the UE transmits a first measurement report, or be referred to as an L1 measurement report, to the source gNB-DU, to transmit an L1 measurement result to the source gNB-DU. The source gNB-DU evaluates the quality of the LTM candidate cells according to the L1 measurement report. If there are LTM candidate cells whose quality is lower than a threshold, the source gNB-DU determines states of the LTM candidate cells of the UE, that is, whether the UE needs to measure the cells or not.
Step 803: the source gNB-DU transmits state information of the LTM candidate cells to the UE, indicates the UE to change the measurement cells, and provides information of the cells that the UE needs to measure. The state information of the LTM candidate cells may be transmitted through a MAC CE or PDCCH channel or DCI or PDCCH. Details about how to indicate the UE to perform change of the measurement cells may refer to the description in Method 2 for Change of Measurement Cells.

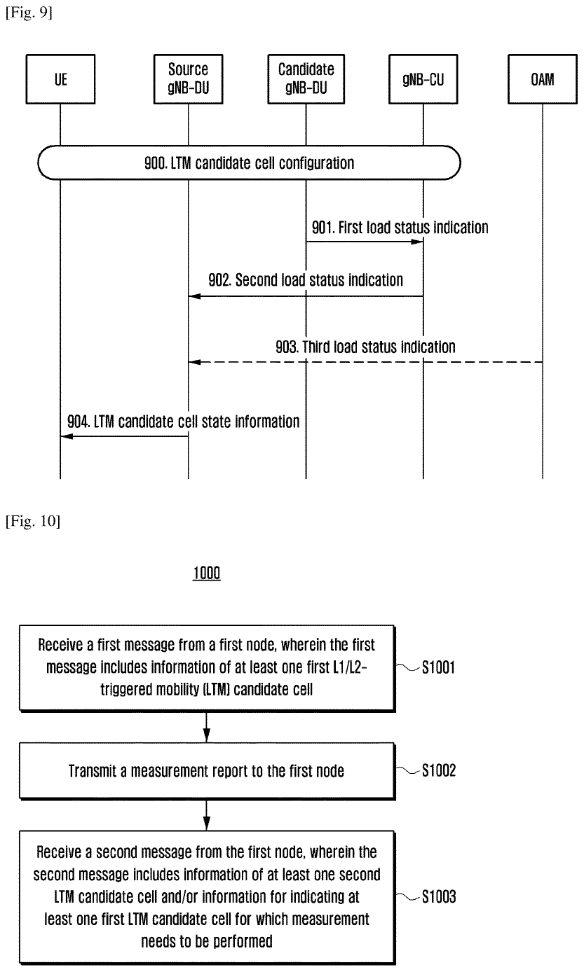

FIG. 9 shows a schematic diagram of an example method according to embodiment 6 of the present disclosure. In the embodiment 6, another L1 measurement cell change process is given.

In the LTM mode, LTM candidate cells are pre-configured by RRC messages. In order to avoid RRC signaling overhead caused by transmitting configuration information of LTM candidate cells, after the UE performs LTM, the UE and the network will continue to store the existing configuration information related to the LTM candidate cells for subsequent LTM handover. In a mobile communication system, the load status of a cell may change dynamically with the movement of the user and the change of the user's service, thus a case that while the quality of an LTM candidate cell (taking Cell0 as an example) stored by the UE meets a threshold, but Cell0 is in an overload status may occur. Because the LTM candidate cell is overloaded, it will not be able to guarantee the quality of service of the UE, and it is not suitable as a target cell for LTM handover of the UE at present. Therefore, if the UE still performs L1 measurement for Cel10, it will waste the power consumption and processing of the UE.

By deleting Cell0 from the LTM candidate cell set and transmitting an RRC message to inform the UE of the change of the candidate cell set, the L1 measurement for Cell0 by UE may be avoided. If the load of Cell0 returns to be normal, Cell0 may be added to the LTM candidate cell set again, and it is necessary to transmit an RRC message to inform the UE of the update of the candidate cell set, thus indicating the UE to perform L1 measurement for Cell0. If an overload status of Cell0 is only temporary, the above operations will cause RRC signaling overhead. Therefore, in the embodiment, the network dynamically indicates the UE of change of measurement cells according to the load status of the LTM candidate cells, which avoids the RRC signaling overhead while avoiding the UE from performing unnecessary measurement. The specific process is shown in FIG. 9.
Step 900: the network decides to change the serving cell of the UE by an LTM mode, and configures LTM candidate cells for the UE.

The source gNB-DU will dynamically indicate L1 measurement cells of the UE according to load status of the LTM candidate cells of the UE. The source gNB-DU may obtain load status information of an LTM candidate cell through gNB-CU or through OAM.
If the source gNB-DU obtains the LTM candidate cell load information of the UE through gNB-CU, Steps 901 and 902 need to be performed.

In this case, if the gNB-DU connected to the gNB-CU monitors that a load status of its cell changes, or the gNB-DU monitors that its own load status changes, such as overload, or the load status returns to be normal, it will transmit a load status indication message to the gNB-CU, that is, perform Step 901.
If the LTM candidate cell load information is obtained through OAM, Step 903 will be performed. Herein, the OAM is connected to the gNB-CU and other candidate gNB-DUs, and acquire states/status of individual cells through the gNB-CU or the other candidate gNB-DUs. The specific cell state information transmission method does not belong to the present disclosure.
Step 901: the candidate gNB-DU transmits a first load status indication message to the gNB-CU, indicating cell load status in the gNB-DU or gNB-DU. The first load status information includes at least one of the following information:
gNB-DU overload information, which indicates the load status of the gNB-DU, and is classified into overloaded and not-overloaded.
radio resource status of a cell, which indicates the usage of radio resources, so as to determine the load status of the cell.

The first load status indication message may be a gNB-DU status indication (GNB-DU STATUS INDICATION) message or a resource status update (RESOURCE STATUS UPDATE) message, or other messages.
Step 902: the gNB-CU transmits a second load status indication message to the source gNB-DU, indicating the load status information of the LTM candidate cells of the UE. The source gNB-DU will indicate the UE of the change of the measurement cells according to the load status of the LTM candidate cells of the UE.

The second load status indication message may be a UE context modification request (UE CONTEXT MODIFICATION REQUEST) message or other messages.
Step 903: the source gNB-DU receives a third load status indication message from the OAM, that is, the load status indication information of the LTM candidate cell of the UE.
Step 904: the source gNB-DU transmits state information of the LTM candidate cells to the UE, providing information of the LTM candidate cells that the UE needs to perform L1 measurement, so as to realize the change of the measurement cells of the UE. The state information of the LTM candidate cells may be transmitted through a MAC CE or PDCCH channel, and for details, please refer to the description in Method 2 for Change of Measurement Cells.

Herein, the source gNB-DU obtains the load status information of the LTM candidate cells of the UE according to Step 902 or through OAM, so as to determine the LTM candidate cells that need to be measured by the UE.
(2) Method for improving handover performance

Embodiment 7 provides a method to reduce service interruption during L1 handover.

In LTM, the UE will be indicated to complete downlink and uplink synchronization with a target cell (or LTM candidate cell) in advance, thus reducing the handover delay of the UE. Since the UE has already completed the uplink synchronization with the target cell in advance, after receiving an LTM handover indication, the UE does not need to perform a Random Access (RA) process, so the UE cannot transmit an LTM handover completion information or message through the uplink grant resources in the RA process to indicate to the target cell that the UE has accessed the cell. Therefore, in LTM, the target cell needs to pre-allocate dedicated resources for the UE to transmit information or messages to the target cell to indicate that it has completed the LTM handover and access the target cell. There are two dedicated resource allocation schemes for the UE to transmit LTM handover completion information or message to the target cell:
Method 1: configuring dedicated uplink data transmission resources, such as PUSCH resources, for MAC CE or RRC messages or uplink data transmitted by the UE, to indicate that the UE completes LTM handover and accesses the target cell.
Method 2: configuring dedicated uplink control message/information transmission resources, such as PUCCH resources, and the UE indicates that the UE completes LTM handover and accesses the target cell by transmitting a Scheduling Request (SR).

The principle of LTM handover is to pre-configure multiple LTM candidate cells for the UE, and the source cell will select a target cell from the LTM candidate cells to perform LTM handover for the UE according to an L1 measurement report provided by the UE. The target cell does not know when the UE will access the target cell, and when the UE performs LTM handover, quality of the dedicated resources pre-allocated to the UE may deteriorate, resulting in the target cell being unable to receive or correctly receive the data or information or message transmitted by the UE indicating that the UE has accessed the cell. Therefore, it may lead to an LTM handover failure and an interruption of service data transmission of the UE.

The present disclosure provides a method to reduce UE service interruption time during LTM handover.

The network sets a timer T1 for the UE, and when the UE receives an LTM handover command, the UE starts the timer T1.
If the timer T1 does not expire:
   If the network only configures dedicated uplink data transmission resources for the UE to transmit LTM handover completion information or message or uplink data, or only configures dedicated uplink control message/information transmission resources for the UE to transmit SR:
      when the number of LTM handover completion information or message or uplink data transmissions the UE has transmitted to the target cell has reached a maximum transmission number, and ACK feedback information indicating successful reception from the target cell has not been received yet, or
      when the SR transmission has reached a maximum transmission number, and the UE has not received uplink grant information (UL Grant) from the target cell yet
         The UE initiates a random access process, and transmits MSG3 or MSGA to the target cell, which carries a C-RNTI (Cell RNTI) configured by the target cell for the UE, for the target cell to identify the UE.
   If the network simultaneously configures dedicated uplink data transmission resources for the UE to transmit an LTM handover completion indication or message and dedicated uplink control message/information transmission resources for transmitting SR:
      when the number of the LTM handover completion information or message or uplink data transmissions transmitted by the UE to the target cell reaches a maximum transmission number, and ACK feedback information indicating successful reception from the target cell has not been received yet, the UE uses the dedicated uplink control message/information transmission resources allocated by the target cell to transmit SR,
         If the UE has not received uplink grant information (UL Grant) from the target cell when the SR transmission reaches the maximum transmission number
         The UE initiates a random access process, and transmits MSG3 or MSGA to the target cell, which carries a C-RNTI configured by the target cell for the UE, for the target cell to identify the UE.
If the timer T1 expires,
   the UE does not receive ACK feedback information indicating successful reception from the target cell, indicating that the target cell has received the LTM handover completion information or message or uplink data, or
   the UE does not receive uplink grant information (UL Grant) from the target cell, or
   if an RA process of the UE to the target cell fails, then
      LTM handover fails

When the LTM handover fails, in order to resume service transmission of the UE as soon as possible, the UE will perform cell selection:

The network configures a timer T2 for the UE. When the LTM handover fails, the UE starts the timer T2 and starts to perform cell selection.
if the selected target cell is an LTM candidate cell
   if the cell allocates dedicated resources for the UE to transmit LTM handover completion information or message, and the UE has been in uplink synchronization with the cell, the UE may directly transmit a MAC CE or RRC message or uplink data or SR request on the dedicated resources to indicate that the UE completes LTM handover and accessed the target cell.
   otherwise, the UE will perform an RA process and transmit the LTM completion indication information or message and a C-RNTI allocated by the cell for the UE to the target cell on MSG3 or MSGB.
   if the UE has received ACK feedback information indicating successful reception from the target cell (indicating that the target cell has received the LTM handover completion information or message or uplink data) or the uplink grant information (UL Grant) before T2 expires, it is considered that the access is successful, otherwise
      an RRC Reestablishment process is performed.
if the selected is not an LTM candidate cell:
   the UE performs an RRC Reestablishment process. Or
   if the LTM handover trigger is for changing the PSCell, that is, LTM handover triggered by SN, if the cell selected by the UE is not the candidate cells of the LTM handover configuration, the UE does not perform a RRC Reestablishment process, but transmits an SCG failure information (SCGFailureInformation) message to the MN, in which measurements results are included. The MN will decide whether to maintain, change or release the SN/SCG according to the measurements results.

When the target cell identifies the UE by receiving the C-RNTI carried in the MSG3 or MSGA message transmitted by the UE, and determines that the target cell is an LTM candidate cell configured for the UE, it is considered that the UE has successfully accessed the cell. At the same time, the target cell transmits indication information to the source cell, indicating that the UE successfully accesses the target cell. After receiving the indication information, the source cell considers that the LTM handover of the UE is completed. Herein, if the source cell and the target cell are not in the same gNB-DU, the candidate gNB-DU where the target cell is located transmits a UE access success (ACCESS SUCCESS) message to the gNB-CU, and then the gNB-CU transmits a message to the source gNB-DU to indicate that the UE successfully accesses the target cell, where the message may be a UE context modification request (UE CONTEXT MODIFCATION REQUEST) message or other messages, which includes an identification of the target cell for the UE handover, which may be a LTMCellIndex or a PhysCellId or a CGI or a Cell Index.

Embodiment 8 provides a method to reduce service interruption during L3 handover.

In case that the network configures both LTM and L3 handover modes for the UE simultaneously, when gNB-CU triggers the UE to perform an L3 handover according to an L3 measurement result, if the L3 handover fails, according to the existing process, the UE will perform cell selection and perform an RRC reestablishment process, thus causing the service interruption of the UE. The present disclosure provides a method to reduce the service interruption time of the UE when L3 handover fails:

The network configures a timer T2 for the UE. When L3 handover fails, the UE starts the timer T2 to perform cell selection.
if the selected target cell is an LTM candidate cell:
   If the target cell allocates dedicated resources for the UE to indicate LTM handover completion to the target cell, and the UE has been in uplink synchronization with the cell, the UE may directly transmit a MAC CE or RRC message or uplink data or SR request for LTM handover completion indication on the dedicated resources to indicate that the UE accessed the target cell.
   otherwise, the UE will perform an RA process and transmit an LTM completion indication message and a C-RNTI allocated by the cell for the UE to the target cell on MSG3 or MSGB.
   If the UE has received ACK feedback information indicating successful reception or uplink grant information (UL Grant) from the target cell before T2 expires, it is considered that the access is successful, otherwise
      the UE performs an RRC Reestablishment process.
if the selected target cell is not an LTM candidate cell:
   The UE performs an RRC Reestablishment process.

In cell selection, if the target cell selected by the UE is an LTM candidate cell, the LTM candidate cell includes the configuration information of the UE therein, and through an LTM handover process, the UE can be guaranteed to access the target cell as soon as possible and resume service transmission, thus reducing the service interruption time of the UE.

Next, FIG. 10 shows a flowchart of a method 1000 performed by a user equipment (UE) in a wireless communication system according to embodiments of the present disclosure. As shown in FIG. 10, the method 1000 may include Steps S1001, S1002 and S1003. In Step S1001, the method 1000 may include receiving a first message from a first node. In some implementations, the first message may include information of at least one first L1/L2-triggered mobility (LTM) candidate cell. In some implementations, the information of at least one first L1/L2-triggered mobility (LTM) candidate cell may be information about the set or identification list of the first LTM candidate cells as described above. In Step S1002, the method 1000 may include transmitting a measurement report to the first node. In some implementations, the measurement report may be an L1 measurement report and/or an L3 measurement report. In Step S1003, the method 1000 may include receiving a second message from the first node. In some implementations, the second message may include information of at least one second LTM candidate cell or information for indicating at least one first LTM candidate cell for which measurement needs to be performed. In some implementations, the first node may be a source gNB-DU node as described above, the second node may be a gNB-CU node as described above, and the messages or signaling exchanged between the first node, the second node and the UE may be various messages or signaling as described above in connection with various drawings or embodiments.

According to embodiments of the present disclosure, the first message further includes L1 measurement configuration information, wherein the L1 measurement configuration information includes a neighboring cell L1 measurement trigger condition; wherein the UE triggers a neighboring cell L1 measurement based on the neighboring cell L1 measurement trigger condition; and wherein the neighboring cell L1 measurement trigger condition includes that a reference signal receiving power (RSRP) value of a special cell is lower than a first neighboring cell measurement threshold.

According to embodiments of the present disclosure, the UE receives the L1 measurement configuration information by the following: the L1 measurement configuration information is received by the UE from a second node; or the L1 measurement configuration information is received by the UE from a second node, wherein the L1 measurement configuration information is received by the second node from the first node after the second node indicates the first node to transmit the L1 measurement configuration information.

According to embodiments of the present disclosure, the first message further includes L3 measurement configuration information, wherein the L3 measurement configuration information includes a neighboring cell L3 measurement trigger condition; wherein the UE triggers a neighboring cell L3 measurement based on the neighboring cell L3 measurement trigger condition; and wherein the neighboring cell L3 measurement trigger condition includes at least one of the following: both reference signal receiving power (RSRP) values of a special cell and an LTM candidate cell are lower than a first neighboring cell measurement threshold, and a RSRP value of a special cell is lower than a second neighboring cell measurement threshold.

According to embodiments of the present disclosure, the first message further includes L3 measurement configuration information, wherein the L3 measurement configuration information includes a condition for event-triggered measurement reporting, wherein the method further includes: when a L3 measurement result meets the condition for event-triggered measurement reporting, the UE transmits a second measurement report to the first node; wherein the condition for event-triggered measurement reporting includes at least one of the following: a measurement result of a serving cell is lower than a threshold; a measurement result of a neighboring cell is higher than a measurement result of a special cell or an LTM candidate cell and exceeds an offset; a measurement result of a special cell or an LTM candidate cell is lower than a first threshold, while a measurement result of a neighboring cell is higher than a second threshold; a measurement result of an LTM candidate cell is lower than a threshold; a measurement result of a neighboring cell is higher than a measurement result of an LTM candidate cell and exceeds an offset; a measurement result of an LTM candidate cell is lower than a first threshold, while a measurement result of a neighboring cell is higher than a second threshold; a measurement result of a neighboring cell is higher than a measurement result of an LTM candidate cell and exceeds an offset.

According to embodiments of the present disclosure, the condition for event-triggered measurement reporting includes an entering condition and a leaving condition of an event, wherein the entering condition and leaving condition include at least one of the following: entering condition: Ms+Hys<Thresh; leaving condition: Ms−Hys>Thresh; or, entering condition: Mn+Ofn+Ocn−Hys>Mp+Ofp+Ocp+Off; leaving condition: Mn+Ofn+Ocn+Hys<Mp+Ofp+Ocp+Off; or, entering condition: Mp+Hys<Thresh1; Mn+Ofn+Ocn−Hys>Thresh2; leaving condition: Mp−Hys>Thresh1; Mn+Ofn+Ocn+Hys<Thresh2; or, entering condition: Ml+Hys<Thresh; leaving condition: Ml−Hys>Thresh; or, entering condition: Mn+Ofn+Ocn−Hys>Ml+Ofl+Ocl+Off; leaving condition: Mn+Ofn+Ocn+Hys<Ml+Ofl+Ocl+Off; or, entering condition: Ml+Hys<Thresh1; Mn+Ofn+Ocn−Hys>Thresh2; leaving condition: Ml−Hys>Thresh1; Mn+Ofn+Ocn+Hys<Thresh2; or, entering condition: Mn+Ocn−Hys>Ml+Ocl+Off; leaving condition: Mn+Ocn+Hys<Ml+Ocl+Off; wherein, Ms is a measurement result of a serving cell; Hys is a hysteresis parameter of an event; Thresh is a threshold of an event; Mn is a measurement result of a neighboring cell; Ofn is a measurement object specific offset of a reference signal of a neighboring cell; Ocn is a cell specific offset of a neighboring cell; Mp is a measurement result of a special cell or LTM candidate cell; Ofp is a measurement object specific offset of a special cell or LTM candidate cell; Ocp is a cell specific offset of a special cell or LTM candidate cell; Off is an offset parameter of an event; Thresh1 is a threshold parameter 1 of an event; Thresh2 is a threshold parameter 2 of an event; Ml is a measurement result of an LTM candidate cell; Ofl is a measurement object specific offset of an LTM candidate cell; Ocl is a cell specific offset of an LTM candidate cell.

According to embodiments of the present disclosure, wherein the measurement report is a first measurement report or a second measurement report, wherein the first measurement report includes an L1 measurement result and the second measurement report includes an L3 measurement result.

According to embodiments of the present disclosure, the method further includes: receiving a third message from the first node, wherein the third message includes an identification of a target cell; wherein if the UE does not successfully access the target cell, the UE performs a random access process, and if the random access process fails, the UE performs cell selection.

According to embodiments of the present disclosure, the method further includes: when LTM handover fails or L3 handover fails, performing cell selection; and if a selected target cell is an LTM candidate cell, transmitting an LTM handover completion indication to the target cell or performing a random access process.

According to embodiments of the present disclosure, performing a random access process includes transmitting a Message 3 (MSG3) or a Message A (MSGA) to the target cell; wherein the MSG3 or MSGA transmitted to the target cell includes a cell radio network temporary identification (C-RNTI) allocated to the UE by the target cell.

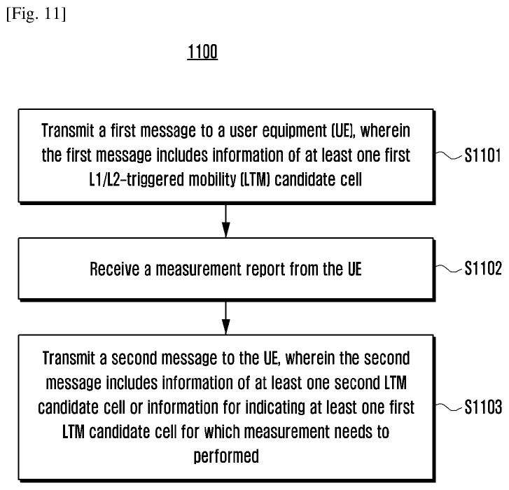

FIG. 11 shows a flowchart of a method 1100 performed by a first node in a wireless communication system according to embodiments of the present disclosure. As shown in FIG. 11, the method 1100 may include Steps S1101, S1102 and S1103. In Step S1101, the method 1100 may include transmitting a first message to a user equipment (UE). In some implementations, the first message may include information of at least one first L1/L2-triggered mobility (LTM) candidate cell. In some implementations, the information of at least one first L1/L2-triggered mobility (LTM) candidate cell may be information about the set or identification list of the first LTM candidate cells as described above. In Step S1102, the method 1100 may include receiving a measurement report from the UE. In some implementations, the measurement report may be an L1 measurement report and/or an L3 measurement report. In Step S1103, the method 1100 may include transmitting a second message to the UE. In some implementations, in some implementations, the second message may include information of at least one second LTM candidate cell or information for indicating at least one first LTM candidate cell for which measurement needs to be performed. In some implementations, the first node may be a source gNB-DU node as described above, the second node may be a gNB-CU node as described above, and the messages or signaling exchanged between the first node, the second node and the UE may be various messages or signaling as described above in connection with various drawings or embodiments.

According to embodiments of the present disclosure, the first message further includes L1 measurement configuration information, wherein the L1 measurement configuration information includes a neighboring cell L1 measurement trigger condition; wherein the UE triggers a neighboring cell L1 measurement based on the neighboring cell L1 measurement trigger condition; and wherein the neighboring cell L1 measurement trigger condition includes that a reference signal receiving power (RSRP) value of a special cell is lower than a first neighboring cell measurement threshold.

According to embodiments of the present disclosure, the UE receives the L1 measurement configuration information by the following: the L1 measurement configuration information is received by the UE from a second node; or the L1 measurement configuration information is received by the UE from a second node, wherein the L1 measurement configuration information is received by the second node from the first node after the second node indicates the first node to transmit the L1 measurement configuration information.

According to embodiments of the present disclosure, the first message further includes L3 measurement configuration information, wherein the L3 measurement configuration information includes a neighboring cell L3 measurement trigger condition; wherein the UE triggers a neighboring cell L3 measurement based on the neighboring cell L3 measurement trigger condition; and wherein the neighboring cell L3 measurement trigger condition includes at least one of the following: both reference signal receiving power (RSRP) values of a special cell and an LTM candidate cell are lower than a first neighboring cell measurement threshold, and a RSRP value of a special cell is lower than a second neighboring cell measurement threshold.

According to embodiments of the present disclosure, the first message further includes L3 measurement configuration information, wherein the L3 measurement configuration information includes a condition for event-triggered measurement reporting, wherein the method further includes: when a L3 measurement result meets the condition for event-triggered measurement reporting, receiving a second measurement report from the UE and transmitting the second measurement report to a second node; wherein the condition for event-triggered measurement reporting includes at least one of the following: a measurement result of a serving cell is lower than a threshold; a measurement result of a neighboring cell is higher than a measurement result of a special cell or an LTM candidate cell and exceeds an offset; a measurement result of a special cell or an LTM candidate cell is lower than a first threshold, while a measurement result of a neighboring cell is higher than a second threshold; a measurement result of an LTM candidate cell is lower than a threshold; a measurement result of a neighboring cell is higher than a measurement result of an LTM candidate cell and exceeds an offset; a measurement result of an LTM candidate cell is lower than a first threshold, while a measurement result of a neighboring cell is higher than a second threshold; a measurement result of a neighboring cell is higher than a measurement result of an LTM candidate cell and exceeds an offset.

According to embodiments of the present disclosure, the condition for event-triggered measurement reporting includes an entering condition and a leaving condition of an event, wherein the entering condition and leaving condition include at least one of the following: entering condition: Ms+Hys<Thresh; leaving condition: Ms−Hys>Thresh; or, entering condition: Mn+Ofn+Ocn−Hys>Mp+Ofp+Ocp+Off; leaving condition: Mn+Ofn+Ocn+Hys<Mp+Ofp+Ocp+Off; or, entering condition: Mp+Hys<Thresh1; Mn+Ofn+Ocn−Hys>Thresh2; leaving condition: Mp−Hys>Thresh1; Mn+Ofn+Ocn+Hys<Thresh2; or, entering condition: Ml+Hys<Thresh; leaving condition: Ml−Hys>Thresh; or, entering condition: Mn+Ofn+Ocn−Hys>Ml+Ofl+Ocl+Off; leaving condition: Mn+Ofn+Ocn+Hys<Ml+Ofl+Ocl+Off; or, entering condition: Ml+Hys<Thresh1; Mn+Ofn+Ocn−Hys>Thresh2; leaving condition: Ml−Hys>Thresh1; Mn+Ofn+Ocn+Hys<Thresh2; or, entering condition: Mn+Ocn−Hys>Ml+Ocl+Off; leaving condition: Mn+Ocn+Hys<Ml+Ocl+Off; wherein, Ms is a measurement result of a serving cell; Hys is a hysteresis parameter of an event; Thresh is a threshold of an event; Mn is a measurement result of a neighboring cell; Ofn is a measurement object specific offset of a reference signal of a neighboring cell; Ocn is a cell specific offset of a neighboring cell; Mp is a measurement result of a special cell or LTM candidate cell; Ofp is a measurement object specific offset of a special cell or LTM candidate cell; Ocp is a cell specific offset of a special cell or LTM candidate cell; Off is an offset parameter of an event; Thresh1 is a threshold parameter 1 of an event; Thresh2 is a threshold parameter 2 of an event; Ml is a measurement result of an LTM candidate cell; Ofl is a measurement object specific offset of an LTM candidate cell; Ocl is a cell specific offset of an LTM candidate cell.

According to embodiments of the present disclosure, the method further includes: if the received measurement report is a second measurement report, transmitting the second measurement report to a second node; and if the received measurement report is a first measurement report, performing one of the following operations: performing LTM handover; transmitting information for indicating at least one first LTM candidate cell for which measurement needs to be performed to the UE; or transmitting a third measurement report to a second node, wherein the third measurement report includes at least one of the following: an L1 measurement result and an identification of a cell with a quality lower than a measurement threshold.

According to embodiments of the present disclosure, the method further includes: receiving load status information of an LTM candidate cell; and transmitting information for indicating at least one first LTM candidate cell for which measurement needs to be performed to the UE.

According to embodiments of the present disclosure, the second message is transmitted to the UE through a Media Access Control Control Element (MAC CE) or downlink control information (DCI).

According to embodiments of the present disclosure, the method further includes: receiving L1 measurement configuration indication information from a second node and transmitting L1 measurement configuration information to the second node, wherein the L1 measurement configuration indication information is used to indicate that the L1 measurement configuration information is provided by the first node.

According to embodiments of the present disclosure, the method further includes: transmitting a third message to the UE, wherein the third message includes an identification of a target cell; wherein if the UE does not successfully access the target cell, the UE performs a random access process, and if the random access process fails, the UE performs cell selection.

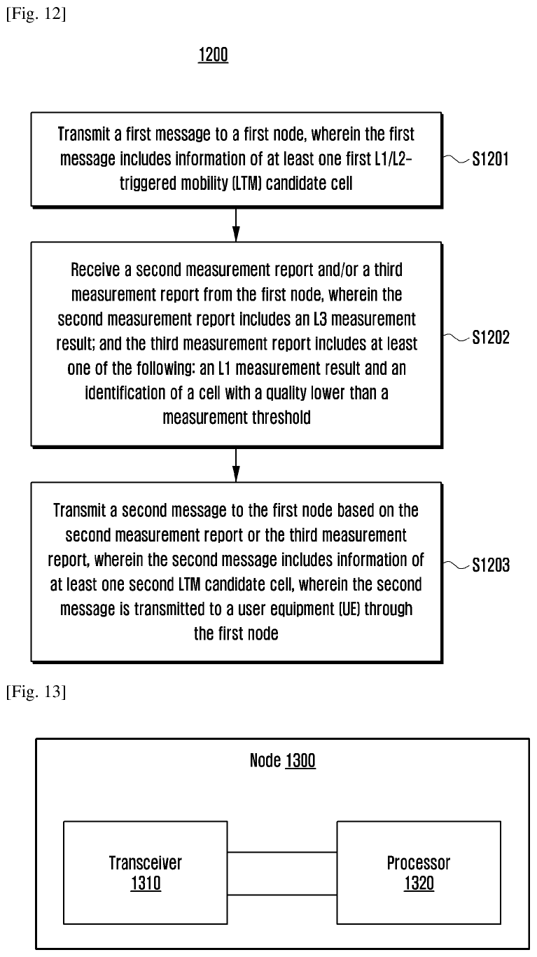

FIG. 12 shows a flowchart of a method 1200 performed by a second node in a wireless communication system according to embodiments of the present disclosure. As shown in FIG. 12, the method 1200 may include Steps S1201, S1202 and S1203. In Step S1201, the method 1200 may include transmitting a first message to a first node. In some implementations, the first message may include information of at least one first L1/L2-triggered mobility (LTM) candidate cell. In Step S1202, the method 1200 may include receiving a second measurement report and/or a third measurement report from the first node. In some implementations, the second measurement report may include an L3 measurement result. In some implementations, the third measurement report may include at least one of the following: the L1 measurement result, and an identification of a cell with a quality lower than a measurement threshold. In Step S1203, the method 1200 may include transmitting a second message to the first node based on the second measurement report or the third measurement report. In some implementations, the second message includes information of at least one second LTM candidate cell, which may be, for example, an identification list of at least one second LTM candidate cell. In some implementations, the second message may be transmitted to the user equipment (UE) through the first node. In some implementations, the first node may be a source gNB-DU node as described above, the second node may be a gNB-CU node as described above, and the messages or signaling exchanged between the first node, the second node and the UE may be various messages or signaling as described above in connection with various drawings or embodiments.

It should be understood that the methods 1000, 1100 and 1200 according to embodiments of the present disclosure may further include one or more of the methods or steps as described above in connection with any examples or drawings, which are not repeated here.

Next, FIG. 13 shows a schematic diagram of a node 1300 in a wireless communication system according to embodiments of the present disclosure.

As shown in FIG. 13, a node 1300 (which may be, for example, a first node (e.g., a source gNB-DU), a second node (e.g., a gNB-CU) or any other network node as described above) according to embodiments of the present disclosure may include a transceiver 1310 and a processor 1320. The transceiver 1310 may be configured to transmit and receive signals. The processor 1320 may be coupled to the transceiver 1310 and may be configured to (e.g., control the transceiver 1310 to) perform any method performed by a node in a wireless communication system according to embodiments of the present disclosure.

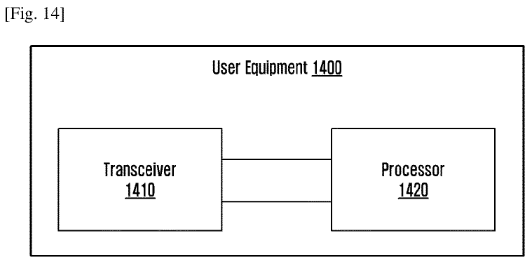

FIG. 14 shows a schematic diagram of a user equipment 1400 in a wireless communication system according to embodiments of the present disclosure.

As shown in FIG. 14, a user equipment 1400 according to embodiments of the present disclosure may include a transceiver 1410 and a processor 1420. The transceiver 1410 may be configured to transmit and receive signals. The processor 1420 may be coupled to the transceiver 1410 and may be configured to (e.g., control the transceiver 1410 to) perform any method performed by a user equipment according to embodiments of the present disclosure. Herein, a processor may also be called a controller.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1. A method performed by a user equipment (UE) in a wireless communication system, the method comprising:
receiving a first message from a first node, wherein the first message includes information of at least one first L1/L2-triggered mobility (LTM) candidate cell or at least one secondary cell information;
transmitting a measurement report to the first node; and
receiving a second message from the first node, wherein the second message includes information of at least one second LTM candidate cell or at least one secondary cell information or information for indicating at least one first LTM candidate cell for which measurement needs to be performed.

2. The method of claim 1,
wherein the first message further includes L1 measurement configuration information, wherein the L1 measurement configuration information includes a neighboring cell L1 measurement trigger condition,
wherein the UE triggers a neighboring cell L1 measurement based on the neighboring cell L1 measurement trigger condition, and
wherein the neighboring cell L1 measurement trigger condition includes that a reference signal receiving power (RSRP) value of a special cell is lower than a first neighboring cell measurement threshold.

3. The method of claim 2,
wherein the L1 measurement configuration information is received by the UE from a second node, and
wherein the L1 measurement configuration information is received by the second node from the first node after the second node indicates the first node to transmit the L1 measurement configuration information.

4. The method of claim 1,
wherein the first message further includes L3 measurement configuration information including a neighboring cell L3 measurement trigger condition,
wherein the UE triggers a neighboring cell L3 measurement based on the neighboring cell L3 measurement trigger condition, and
wherein the neighboring cell L3 measurement trigger condition includes at least one of the following:
both reference signal receiving power (RSRP) values of a special cell and an LTM candidate cell are lower than a first neighboring cell measurement threshold, or a RSRP value of a special cell is lower than a second neighboring cell measurement threshold.

5. The method of claim 1, wherein the first message further includes L3 measurement configuration information including a condition for event-triggered measurement reporting,
wherein the method further includes:
in case that a L3 measurement result meets the condition for event-triggered measurement reporting, transmitting a second measurement report to the first node;
wherein the condition for event-triggered measurement reporting includes at least one of the following:
a measurement result of a serving cell is lower than a threshold;
a measurement result of a neighboring cell is higher than a measurement result of a special cell or an LTM candidate cell and exceeds an offset;
a measurement result of a special cell or an LTM candidate cell is lower than a first threshold, while a measurement result of a neighboring cell is higher than a second threshold;
a measurement result of an LTM candidate cell is lower than a threshold;
a measurement result of a neighboring cell is higher than a measurement result of an LTM candidate cell and exceeds an offset;
a measurement result of an LTM candidate cell is lower than a first threshold, while a measurement result of a neighboring cell is higher than a second threshold; or
a measurement result of a neighboring cell is higher than a measurement result of an LTM candidate cell and exceeds an offset.

6. The method of claim 1, further comprising:
receiving a third message from the first node, wherein the third message includes an identification of a target cell;
wherein in case that the UE does not successfully access the target cell, performing a random access process;
wherein in case that the random access process fails, performing cell selection;
in case that LTM handover fails or handover fails, performing cell selection; and
in case that a selected target cell is an LTM candidate cell, transmitting an LTM handover completion indication to the target cell or performing a random access process.

7. A method performed by a first node in a wireless communication system, the method comprising:
transmitting a first message to a user equipment (UE), wherein the first message includes information of at least one first L1/L2-triggered mobility (LTM) candidate cell or at least one secondary cell information;
receiving a measurement report from the UE; and
transmitting a second message to the UE, wherein the second message includes information of at least one second LTM candidate cell or at least one secondary cell information or information for indicating at least one first LTM candidate cell for which measurement needs to be performed.

8. The method of claim 7, wherein the first message further includes L1 measurement configuration information, wherein the L1 measurement configuration information includes a neighboring cell L1 measurement trigger condition,
wherein the UE triggers a neighboring cell L1 measurement based on the neighboring cell L1 measurement trigger condition, and
wherein the neighboring cell L1 measurement trigger condition includes that a reference signal receiving power (RSRP) value of a special cell is lower than a first neighboring cell measurement threshold.

9. The method of claim 8,
wherein the L1 measurement configuration information is received by the UE from a second node, and
wherein the L1 measurement configuration information is received by the second node from the first node after the second node indicates the first node to transmit the L1 measurement configuration information.

10. The method of claim 7,
wherein the first message further includes L3 measurement configuration information including a neighboring cell L3 measurement trigger condition,
wherein the UE triggers a neighboring cell L3 measurement based on the neighboring cell L3 measurement trigger condition, and
wherein the neighboring cell L3 measurement trigger condition includes at least one of the following:
both reference signal receiving power (RSRP) values of a special cell and an LTM candidate cell are lower than a first neighboring cell measurement threshold, or a RSRP value of a special cell is lower than a second neighboring cell measurement threshold.

11. The method of claim 7,
wherein the method further includes:
in case that the received measurement report is a second measurement report, transmitting the second measurement report to a second node; and
in case that the received measurement report is a first measurement report, performing one of the following operations:
performing LTM handover;
transmitting information for indicating at least one first LTM candidate cell for which measurement needs to be performed to the UE; or
transmitting a third measurement report to a second node, wherein the third measurement report includes at least one of the following: an L1 measurement result or an identification of a cell with a quality lower than a measurement threshold.

12. The method of claim 7, further including:
receiving load status information of an LTM candidate cell; and
transmitting information for indicating at least one first LTM candidate cell for which measurement needs to be performed to the UE.

13. A user equipment (UE) in a wireless communication system, the UE comprising:
a transceiver; and
a processor coupled with the transceiver, and configured to:
receive, a first message from a first node, wherein the first message includes information of at least one first L1/L2-triggered mobility (LTM) candidate cell or at least one secondary cell information,
transmit a measurement report to the first node, and
receive a second message from the first node, wherein the second message includes information of at least one second LTM candidate cell or at least one secondary cell information or information for indicating at least one first LTM candidate cell for which measurement needs to be performed.

14. The UE of claim 13,
wherein the first message further includes L1 measurement configuration information, wherein the L1 measurement configuration information includes a neighboring cell L1 measurement trigger condition,
wherein the UE triggers a neighboring cell L1 measurement based on the neighboring cell L1 measurement trigger condition, and
wherein the neighboring cell L1 measurement trigger condition includes that a reference signal receiving power (RSRP) value of a special cell is lower than a first neighboring cell measurement threshold.

15. A first node in a wireless communication system, the first node comprising:
a transceiver; and
a processor coupled with the transceiver, and configured to:
transmit a a first message to a user equipment (UE), wherein the first message includes information of at least one first L1/L2-triggered mobility (LTM) candidate cell or at least one secondary cell information,
receive a measurement report from the UE, and
transmit a second message to the UE, wherein the second message includes information of at least one second LTM candidate cell or at least one secondary cell information or information for indicating at least one first LTM candidate cell for which measurement needs to be performed.
